(19) United States
(12) Patent Application Publication
(10) Pub. No.: US 2017/0228775 A1
(43) Pub. Date: Aug. 10, 2017

(54) LEARNING APPARATUS, LEARNING METHOD, AND NON-TRANSITORY COMPUTER READABLE STORAGE MEDIUM

(71) Applicant: YAHOO JAPAN CORPORATION, Tokyo (JP)

(72) Inventor: Kenichi YAMADA, Tokyo (JP)

(73) Assignee: YAHOO JAPAN CORPORATION, Tokyo (JP)

(21) Appl. No.: 15/416,228

(22) Filed: Jan. 26, 2017

(30) Foreign Application Priority Data
Feb. 5, 2016 (JP) 2016-020665

(51) Int. Cl. G06Q 30/02; G06N 99/00

(52) U.S. Cl. CPC G06Q 30/0255; G06N 99/005

(57) ABSTRACT

A learning apparatus according to the subject application includes an acquisition unit, a generating unit, and a specifying unit. The acquisition unit acquires terminal information that is information about a terminal device receiving information content. The generating unit generates a model indicating a tendency of predetermined behavior related to predetermined information content to be taken, by learning the relation between result information indicating whether the predetermined behavior related to the predetermined information content has been taken and terminal information acquired by the acquisition unit. The specifying unit specifies a terminal device to serve as a destination receiving the predetermined information content, based on the model generated by the generating unit.

### CROSS-REFERENCE TO RELATED APPLICATION(S)

The present application claims priority to and incorporates by reference the entire contents of Japanese Patent Application No. 2016-020665 filed in Japan on Feb. 5, 2016.

### BACKGROUND OF THE INVENTION

1. Field of the Invention

The present invention relates to a learning apparatus, a learning method, and a non-transitory computer readable storage medium having stored therein a learning program.

2. Description of the Related Art

With the recent proliferation of the Internet, information provision via the Internet has become popular. An example of the information provision is distribution of Internet advertisements. For example, in a portable terminal such as a smartphone, advertisements such as banners appear together with content on the display screen in which application programs (hereinafter referred to as “app”) or browsers display content. The user clicks on such an advertisement to display, for example, a download site of an app associated with the advertisement.

The user may install an app into the portable terminal through the advertisement as described above. As a technique related to installation of apps, there is a known technique that transmits information about the installed app alone to a server (for example, Japanese Patent Application Laid-open No. 2014-167688). There is also a known technique in which when users perform a selection operation offline, the selection operation is stored to allow a predetermined process to be performed when users go online (for example, Japanese Patent Application Laid-open No. 2013-257683).

Unfortunately, with the conventional techniques above, the provided information content is not always appropriately matched with a destination user. Since distribution of advertisements (an example of information content) costs much, it is desirable to advertisers that advertisements are preferentially distributed to users for whom the advertisements are likely to be effective. Unfortunately, although the conventional techniques above can measure the effectiveness of the distributed advertisement, it is difficult to accurately extract users for whom the advertisement is likely to be effective, for example, users likely to install a new app through the advertisement.

### SUMMARY OF THE INVENTION

It is an object of the present invention to at least partially solve the problems in the conventional technology.

A learning apparatus according to the present application includes an acquisition unit that acquires terminal information that is information about a terminal device receiving information content and a generating unit that generates a model indicating a tendency of predetermined behavior related to predetermined information content to be taken, by learning a relation between result information and the terminal information acquired by the acquisition unit, the result information indicating whether the predetermined behavior related to the predetermined information content has been taken and a specifying unit that specifies a terminal device to serve as a destination receiving the predetermined information content, based on the model generated by the generating unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a learning process according to an embodiment;

FIG. 2 is a first diagram illustrating an example of terminal information according to the embodiment;

FIG. 3 is a second diagram illustrating an example of terminal information according to the embodiment;

FIG. 4 is a diagram illustrating a configuration example of a learning process system according to the embodiment;

FIG. 5 is a diagram illustrating a configuration example of a learning apparatus according to the embodiment;

FIG. 6 is a diagram illustrating an example of an advertising information storage unit according to the embodiment;

FIG. 7 is a diagram illustrating an example of an attribute table according to the embodiment;

FIG. 8 is a diagram illustrating an example of a device table according to the embodiment;

FIG. 9 is a diagram illustrating an example of an app table according to the embodiment;

FIG. 10 is a first diagram illustrating an example of a setting table according to the embodiment;

FIG. 11 is a second diagram illustrating an example of the setting table according to the embodiment;

FIG. 12 is a diagram illustrating an example of a variable table according to the embodiment;

FIG. 13 is a diagram illustrating an example of a model table according to the embodiment;

FIG. 14 is a diagram illustrating a configuration example of a user terminal according to the embodiment;

FIG. 15 is a first flowchart illustrating a process procedure according to the embodiment;

FIG. 16 is a second flowchart illustrating a process procedure according to the embodiment; and

FIG. 17 is a hardware configuration diagram illustrating an example of a computer implementing the functions of the learning apparatus.

### DETAILED DESCRIPTION OF THE PREFERRED EMBODIMENTS

Modes for carrying out a learning apparatus, a learning method, and a non-transitory computer readable storage medium having stored therein a learning program according to the subject application (hereinafter referred to as “embodiments”) will be described in details below with reference to the figures. It should be noted that the learning apparatus, the learning method, and the non-transitory computer readable storage medium having stored therein the learning program according to the subject application are not intended to be limited by the embodiments. The embodiments can be combined as appropriate without causing a contradiction in the processing. In the embodiments below, the same parts are denoted with the same reference signs and will not be further elaborated here.

1. Example of Learning Process

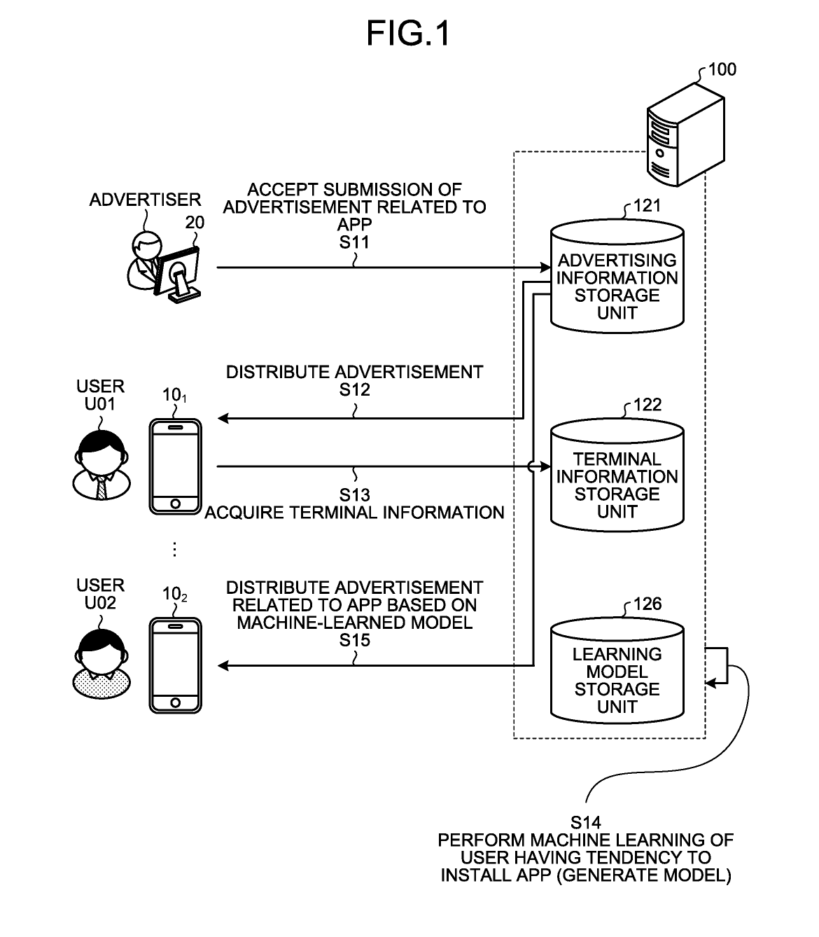

First of all, an example of the learning process according to an embodiment will be described with reference to FIG. 1 to FIG. 3. FIG. 1 is a diagram illustrating an example of the learning process according to the embodiment. In the example illustrated in FIG. 1, a learning apparatus 100 according to the subject application performs the process of learning the relation between result information indicating whether predetermined behavior related to predetermined information content has been taken and terminal information of a destination user terminal 10₁ to receive the predetermined information content. In the embodiment, an advertisement appearing on a web page to advertise a predetermined app is illustrated as an example of information content. In this case, the information provider is an advertiser. In the embodiment, the behavior of installing an app corresponding to a predetermined advertisement into a terminal device will be described as an example of the predetermined behavior related to predetermined information content.

The learning apparatus 100 illustrated in FIG. 1 is a server device that holds advertisements submitted from advertisers. When accepting a request for advertisement distribution from the terminal device operated by a user, the learning apparatus 100 selects an advertisement to be distributed to the terminal device from among the held advertisements. The learning apparatus 100 then distributes the selected advertisement to the terminal device.

User terminals 10₁ and 10₂ illustrated in FIG. 1 are information processing terminals such as smartphones. In the embodiment, the user terminal 10₁ is used by a user U01. The user terminal 10₂ is used by a user U02. When the acquired content (for example, web page) includes an advertisement display region, the user terminals 10₁ and 10₂ request the learning apparatus 100 to distribute an advertisement to be displayed in the advertisement display region. The user terminals 10₁ and 10₂ then display the acquired advertisement in the advertisement display region. The user terminals 10₁ and 10₂ are denoted as “user terminal 10” unless they need to be distinguished from each other.

An advertiser terminal 20 illustrated in FIG. 1 is a terminal device used by an advertiser. For example, the advertiser terminal 20 submits an advertisement to the learning apparatus 100 in accordance with the operation by the advertiser. In the embodiment, the advertisement submitted by the advertiser is associated with an app to be advertised. For example, when the user clicks on an advertisement displayed on the user terminal 10, the user terminal 10 installs an app associated with the advertisement. Alternatively, the user terminal 10 switches the screen display to the download page for the app associated with the advertisement.

In FIG. 1, when accepting a request for advertisement distribution from the user terminal 10, the learning apparatus 100 determines an appropriate advertisement to be distributed to the user terminal 10, that is, an advertisement supposed to achieve a high advertising effectiveness. For example, when an advertisement associated with an app is distributed, the learning apparatus 100 determines whether, in the distribution destination user terminal 10, the app associated with the advertisement is likely to be installed in the user terminal 10. For the above-noted determination process, the learning apparatus 100 generates a model for evaluating the possibility that the app is installed in the user terminal 10. The learning apparatus 100 then uses the generated model to specify a user terminal 10 to serve as a distribution destination of the advertisement. For example, the learning apparatus 100 specifies a distribution destination user terminal 10 by calculating an index value such as the probability that an app is installed when an advertisement is distributed to the user terminal 10, based on the model. Referring to FIG. 1, an example of the learning process performed by the learning apparatus 100 will be described below in order.

First of all, the learning apparatus 100 accepts submission of an advertisement related to an app from the advertiser through the advertiser terminal 20 (step S11). The learning apparatus 100 stores the accepted advertisement into an advertising information storage unit 121. The learning apparatus 100 specifies the app associated with the advertisement. The learning apparatus 100 then performs the process of generating a model for the app as a process target. That is, the learning apparatus 100 generates a model for each app. In other words, a model is generated for each advertisement when there is a one-to-one correspondence between app and advertisement. The learning apparatus 100 distributes advertisements submitted from the advertiser to the user terminal 10 without using a model until information required for generating a model is accumulated (step S12). In the example in FIG. 1, the user terminal 10 to which an advertisement is distributed without using a model may be denoted as user terminal 10₁.

Subsequently, the learning apparatus 100 acquires terminal information that is information about the user terminal 10₁, from the user terminal 10₁ receiving the advertisement associated with the app set as a process target (step S13). Although not illustrated in FIG. 1, a sufficient number of user terminals 10₁ receiving the advertisement exist. The terminal information, which will be detailed later, includes feature information indicating the identity of each user who uses the user terminal 10₁. The learning apparatus 100 can therefore acquire the terminal information to grasp the tendency as to what feature the user U01 using the user terminal 10₁ has. The learning apparatus 100 stores the acquired terminal information into a terminal information storage unit 122.

The learning apparatus 100 also acquires result information as to whether the app has actually been installed in the user terminal 10₁ receiving the advertisement associated with the app set as a process target. That is, the learning apparatus 100 acquires result information as to whether the app has been installed, for each user terminal 10₁ receiving the advertisement, and also acquires the terminal information from the user terminal 10₁.

The learning apparatus 100 then generates a model indicating the tendency to install the app set as a process target, by learning the relation between the result information indicating whether the app set as a process target has been installed and the terminal information acquired from the user terminal 10₁ receiving the advertisement. In other words, the learning apparatus 100 performs machine learning for the user U01 having a tendency to install the app (step S14). More specifically, the learning apparatus 100 generates a model in which the result information indicating whether the app set as a process target has been installed is a response variable, and the feature information extracted from the terminal information and assumed to indicate the feature of the user is an explanatory variable. The learning apparatus 100 stores the generated model into a learning model storage unit 126.

The learning apparatus 100 distributes the advertisement related to the app to the user terminal 10₂, using the model generated based on the result of machine learning (step S15). By using the generated model, the learning apparatus 100 can accurately specify the user who has a tendency to install the app set as a process target. For example, when accepting a request for advertisement distribution from the user terminal 10₂, the learning apparatus 100 acquires the terminal information of the user terminal 10₂. The learning apparatus 100 then inputs the terminal information acquired from the user terminal 10₂, which is a candidate for advertisement distribution destination, to the model. The learning apparatus 100 determines whether the user terminal 10₂ is used by the user U02 likely to install the app, based on information output from the model. If it is determined that the user terminal 10₂ is used by the user U02 likely to install the app, the learning apparatus 100 specifies the user terminal 10₂ as an advertisement distribution destination. The learning apparatus 100 then distributes the advertisement associated with the app to the user terminal 10₂.

In this way, the learning apparatus 100 acquires terminal information that is information about the user terminal 10 receiving an advertisement. The learning apparatus 100 also generates a model indicating the tendency of the app associated with the advertisement to be installed, by learning the relation between the result information indicating whether the app associated with the advertisement has been installed and the acquired terminal information. The learning apparatus 100 then specifies the user terminal 10 to serve as a distribution destination to receive the advertisement, based on the generated model.

That is, the learning apparatus 100 generates a model for determining a user likely to take predetermined behavior such as installing the app associated with the advertisement, based on the terminal information. The learning apparatus 100 then specifies an advertisement distribution destination based on the model to distribute the advertisement to a user who has a similar tendency to the user who installed the app in the past. The learning apparatus 100 can therefore increase the possibility that the app associated with the advertisement is installed, compared with when the advertisement is distributed without using a model. In other words, the learning apparatus 100 can improve the advertising effectiveness achieved by the distributed advertisement. In this way, the learning apparatus 100 appropriately matches the advertisement to be distributed with a distribution destination user.

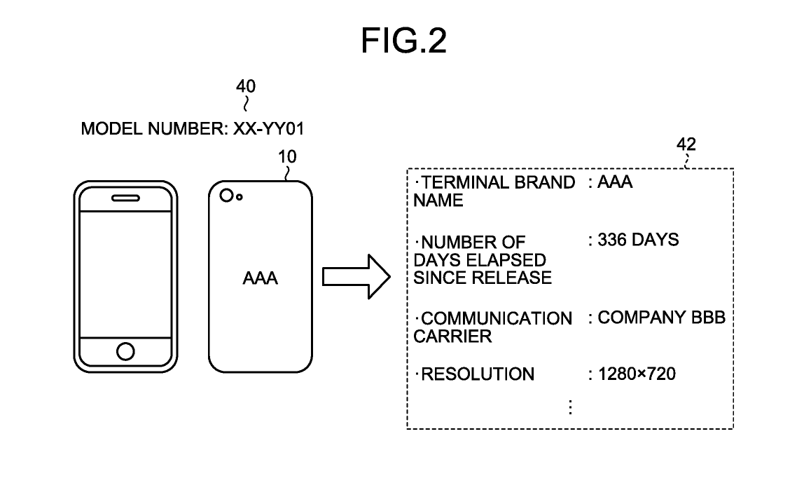

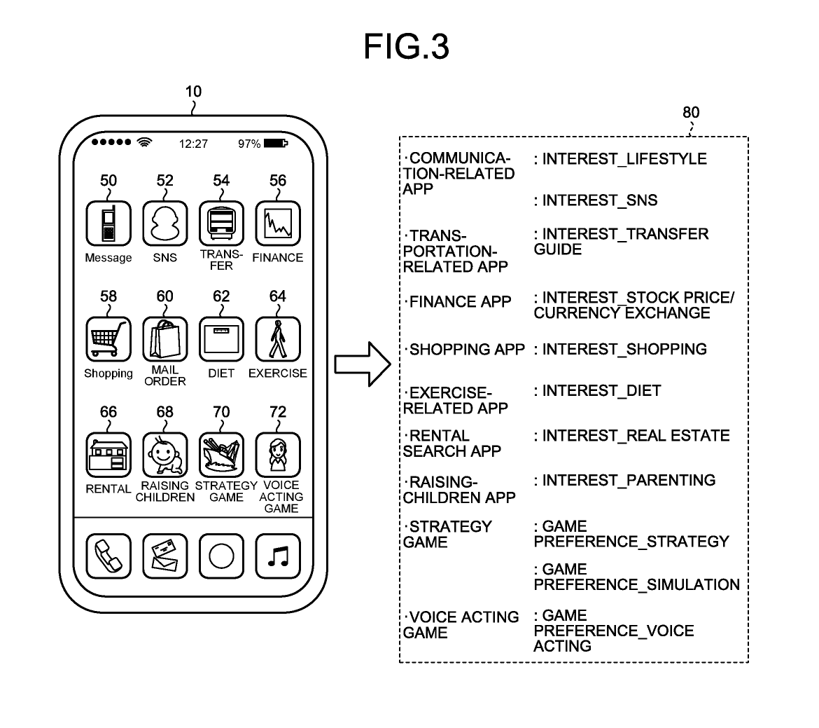

In the example illustrated in FIG. 1, the learning apparatus 100 generates a model using the terminal information of the user terminal 10₁ receiving the advertisement. In this case, in order to increase the accuracy of the model, preferably, the learning apparatus 100 extracts much information precisely characterizing the user U01 from the terminal information. Referring now to FIG. 2 and FIG. 3, an example of the terminal information acquired by the learning apparatus 100 will be described.

FIG. 2 is a first diagram illustrating an example of the terminal information according to the embodiment. In FIG. 2, the information held by the user terminal 10 itself (hereinafter denoted as “device information”) will be described as an example of the terminal information.

The learning apparatus 100 acquires the terminal information of the user terminal 10, for example, when accepting a request for advertisement distribution from the user terminal 10. The device information included in the terminal information is, for example, a model number 40 set for the user terminal 10. The learning apparatus 100 acquires information on the model number 40, for example, by acquiring identification information unique to the device that is transmitted from the user terminal 10. In addition, the learning apparatus 100 also acquires feature information 42 extracted from the model number 40, as an example of the device information. For example, when the manufacturer of the user terminal 10 gives the user terminal 10 a brand name, the learning apparatus 100 extracts the brand name as feature information, based on the model number 40. In the example in FIG. 2, it is assumed that the user terminal 10 is given a brand name “AAA” by the manufacturer. The learning apparatus 100 can perform the extraction process as described above by referring to a predetermined database storing the association between the model number 40 and the brand name “AAA”.

The learning apparatus 100 also extracts, for example, feature information that “336 days” have passed since the release of the user terminal 10, based on the model number 40. The learning apparatus 100 also extracts feature information that the communication carrier is Company “BBB”, based on the model number 40. The learning apparatus 100 also extracts feature information that the resolution of the screen of the user terminal 10 is “1280×720”, based on the model number 40.

The learning apparatus 100 sets the model number 40, the feature information 42, and others extracted from the terminal information, as elements that characterize the user terminal 10. In other words, the learning apparatus 100 extracts the features of the user who uses the user terminal 10, based on the terminal information. This indicates that the model number 40 and the feature information 42 of the user terminal 10 function as the elements that characterize the user.

For example, it is assumed that the brand name “AAA” of the user terminal 10 is the brand commonly favored by males and has a sophisticated image. In this case, the user who uses the user terminal 10 given the brand name “AAA” is presumably male and such a person that likes a sophisticated image. In this way, the learning apparatus 100 can use the brand name of the user terminal 10 as an element that characterizes the person named user U01. The learning apparatus 100 treats “the number of days elapsed since the release” as a characterizing element as to whether the user who uses the user terminal 10 is the type of person who prefers new things. The learning apparatus 100 treats “communication carrier” as a characterizing element as to whether the user who uses the user terminal 10 desires a stable communication line or cheap services. The learning apparatus 100 treats “resolution” as a characterizing element as to whether the user prefers relatively large screens.

The learning apparatus 100 then generates a model that reflects the features of users, by using the acquired device information as one of the explanatory variables in the model. For example, the learning apparatus 100 learns whether there is a predetermined relation between the tendency of the user to install the app set as a process target and the brand name “AAA” of the user terminal 10 used by the user. Similarly, the learning apparatus 100 learns what relation exists between the tendency of the user to install the app set as a process target and the number of days since the release of the user terminal 10, the communication carrier, and the resolution. In this way, the learning apparatus 100 can use the information held by the user terminal 10 itself, as an example of elements that characterize the user of the user terminal 10.

The learning apparatus 100 can use additional different information as the terminal information in the learning. This point will be described with reference to FIG. 3. FIG. 3 is a second diagram illustrating an example of terminal information according to the embodiment. In FIG. 3, the information about apps installed in the user terminal 10 (hereinafter denoted as “app information”) will be described as an example of the terminal information. FIG. 3 illustrates a plurality of apps installed in the user terminal 10.

In the example illustrated in FIG. 3, the user of the user terminal 10 has installed communication-related apps 50 and 52 for communicating with other users in the user terminal 10. The user also has installed a transportation-related app 54, a finance app 56, shopping apps 58 and 60, exercise-related apps 62 and 64, a rental search app 66, a raising-children app 68, a strategy game app 70, and a voice acting game app 72.

Here, the learning apparatus 100 refers to a predetermined database that stores therein the association between the apps installed in the user terminal 10 and the feature information serving as elements characterizing the user. For example, in the predetermined database, the communication-related apps 50 and 52 are associated with feature information such as “lifestyle” and “social networking service (SNS)”. This association is based on the assumption that the user who uses the type of apps having the main function of communication with other users, such as the communication-related apps 50 and 52, tends to be interested in such elements as “lifestyle” and “SNS”. Similarly, the transportation-related app 54 is associated with feature information such as “transfer guide”, and the finance app 56 is associated with feature information such as “stock price/currency exchange”.

The learning apparatus 100 then extracts feature information serving as elements characterizing the user, based on the apps installed in the user terminal 10. For example, the learning apparatus 100 acquires terminal information that the communication-related apps 50 and 52 are installed in the user terminal 10. In this case, the learning apparatus 100 characterizes the user who uses the user terminal 10 as being interested in “lifestyle” and “SNS”.

Specifically, when the communication-related apps 50 and 52 are installed in the user terminal 10, the learning apparatus 100 applies variables such as “interest_lifestyle” and “interest_SNS”, as explanatory variables for explaining the user terminal 10, to the user terminal 10. When the transportation-related app 54 and the finance app 56 are installed, the learning apparatus 100 applies variables such as “interest_transfer guide” and “interest_stock price/currency exchange” as appropriate to the user terminal 10.

When a game-related app is installed in the user terminal 10, the learning apparatus 100 may apply a variable different from variables used for apps other than games. This is because in the case of game-related apps, the characterization of the user is subdivided according to the types of games to produce an element showing the feature of the user more exactly.

For example, when a game app is installed in the user terminal 10, the learning apparatus 100 applies a variable classified by the type “game preference”, as an explanatory variable for explaining the user terminal 10, to the user terminal 10. Specifically, when the strategy game app 70 is installed in the user terminal 10, the learning apparatus 100 applies variables such as “game preference_strategy” and “game preference_simulation” to the user terminal 10. When the voice acting game app 72 is installed, the learning apparatus 100 applies variables such as “game preference voice acting” and “game preference_breeding” to the user terminal 10. Feature information 80 that is a set of variables extracted from apps installed in the user terminal 10 is generated for each user terminal 10 (that is, for each user).

As described above, the learning apparatus 100 can generate a model that reflects the features of the user, by using the acquired app information as elements of explanatory variables in the model. That is, the learning apparatus 100 learns what relation holds between whether the user has a tendency to install the app set as a process target and the apps used by the user. For example, the learning apparatus 100 learns the relation between the user who installs the app set as a process target and the apps used by the user other than the process target. The learning apparatus 100 thus can generate a model capable of evaluating the user using what type of apps is likely to install the app set as a process target in the future. In this way, the learning apparatus 100 uses the app information of apps installed in the user terminal 10, as an example of elements characterizing the user of the user terminal 10. The learning apparatus 100 may also use the total number of apps installed in the user terminal 10, the number of game apps, the number of apps other than games, and the like, as the app information in learning, as will be detailed later.

As described above, the learning apparatus 100 generates a model indicating the tendency of the app set as a process target to be installed in the user terminal 10, by using the terminal information that can be acquired from the user terminal 10. A configuration of the learning apparatus 100 performing such processing and a learning process system 1 including the learning apparatus 100 will be described in details below.

2. Configuration of Learning Process System

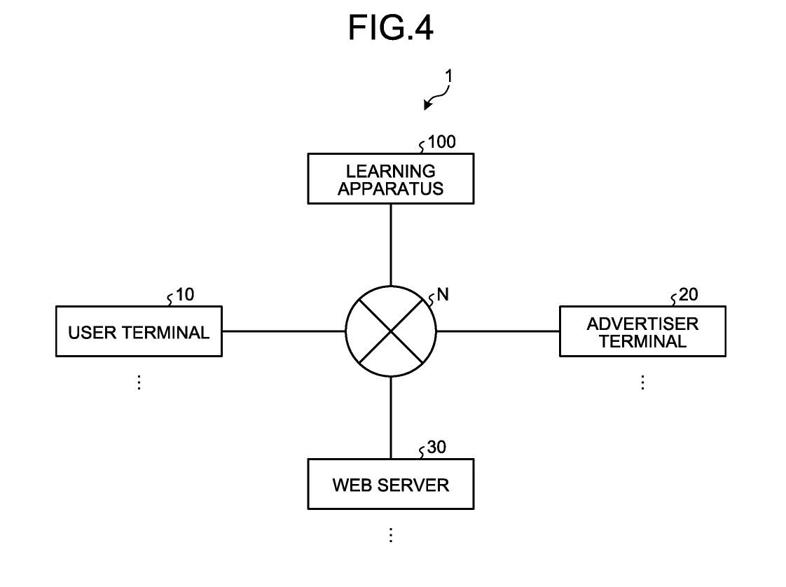

Referring to FIG. 4, a configuration of the learning process system 1 including the learning apparatus 100 according to the embodiment will be described. FIG. 4 is a diagram illustrating a configuration example of the learning process system 1 according to the embodiment. As illustrated in FIG. 4, the learning process system 1 according to the embodiment includes the user terminal 10, the advertiser terminal 20, the web server 30, and the learning apparatus 100. These devices are connected to communicate by wire or by radio through a network N. The learning process system 1 illustrated in FIG. 4 may include a plurality of user terminals 10, a plurality of advertiser terminals 20, and a plurality of web servers 30.

The user terminal 10 is, for example, an information processing apparatus such as a smartphone, a desk-top personal computer (PC), a notebook PC, a tablet terminal, a mobile phone, a personal digital assistant (PDA), or a wearable device. The user terminal 10 accesses the web server 30 in accordance with the user operation to acquire a web page from a web site provided by the web server 30. The user terminal 10 then displays the acquired web page on a display device (for example, a liquid crystal display). In the present description, the user may be identified as the user terminal 10. For example, “providing the user with information content” may actually mean “providing the user terminal 10 used by the user with information content”.

The advertiser terminal 20 is an information processing apparatus used by an advertiser that requests advertisement distribution from the learning apparatus 100. The advertiser terminal 20 submits an advertisement related to an app to the learning apparatus 100 in accordance with an operation by the advertiser.

The advertiser may request an agency, for example, to submit an advertisement using the advertiser terminal 20, rather than submitting to the learning apparatus 100. In this case, an agency submits an advertisement to the learning apparatus 100. In the following, the term “advertiser” is a concept including not only advertiser but also agency, and the term “advertiser terminal” is a concept including not only advertiser terminal but also agency device used by the agency.

The web server 30 is a server device that provides a variety of web pages when being accessed by the user terminal 10. The web server 30 provides a variety of web pages related to, for example, news sites, weather forecast sites, shopping sites, finance (stock price) sites, transfer search sites, map providing sites, travel sites, restaurant recommendations sites, and web blogs.

As previously mentioned, the web page provided by the web server 30 includes an advertisement space that is a display region for displaying advertisements. The web page including the advertisement space includes an acquisition instruction to acquire information content to be displayed in the advertisement space. For example, in a HyperText Markup Language (HTML) file to form a web page, the URL of the learning apparatus 100, for example, is written as an acquisition instruction. The user terminal 10 acquiring the web page accesses the URL written in the HTML file to receive an advertisement distributed from the learning apparatus 100.

The learning apparatus 100 is a server device that appropriately specifies a user terminal 10 to serve as a distribution destination for the advertisement accepted from the advertiser terminal 20. As previously mentioned, the learning apparatus 100 generates a model based on the result information indicating whether the app has been installed in a user terminal 10 and the terminal information of the user terminal 10. The learning apparatus 100 then specifies a user terminal 10 to serve as a distribution destination, using the generated model.

As previously mentioned, in distribution of an advertisement, the learning apparatus 100 identifies the user terminal 10 and acquires the terminal information of the user terminal 10. For example, the terminal information of the user terminal 10 can be acquired by embedding information in cookies exchanged between the web browser or the browser app of the user terminal 10 and the learning apparatus 100. However, the method for acquiring the terminal information is not limited to the one described above. For example, a dedicated program may be set in the user terminal 10, and the dedicated program may transmit terminal information to the learning apparatus 100. Alternatively, the learning apparatus 100 may acquire the terminal information of the user terminal 10 from the web server 30 accessed by the user terminal 10.

3. Configuration of Learning Apparatus

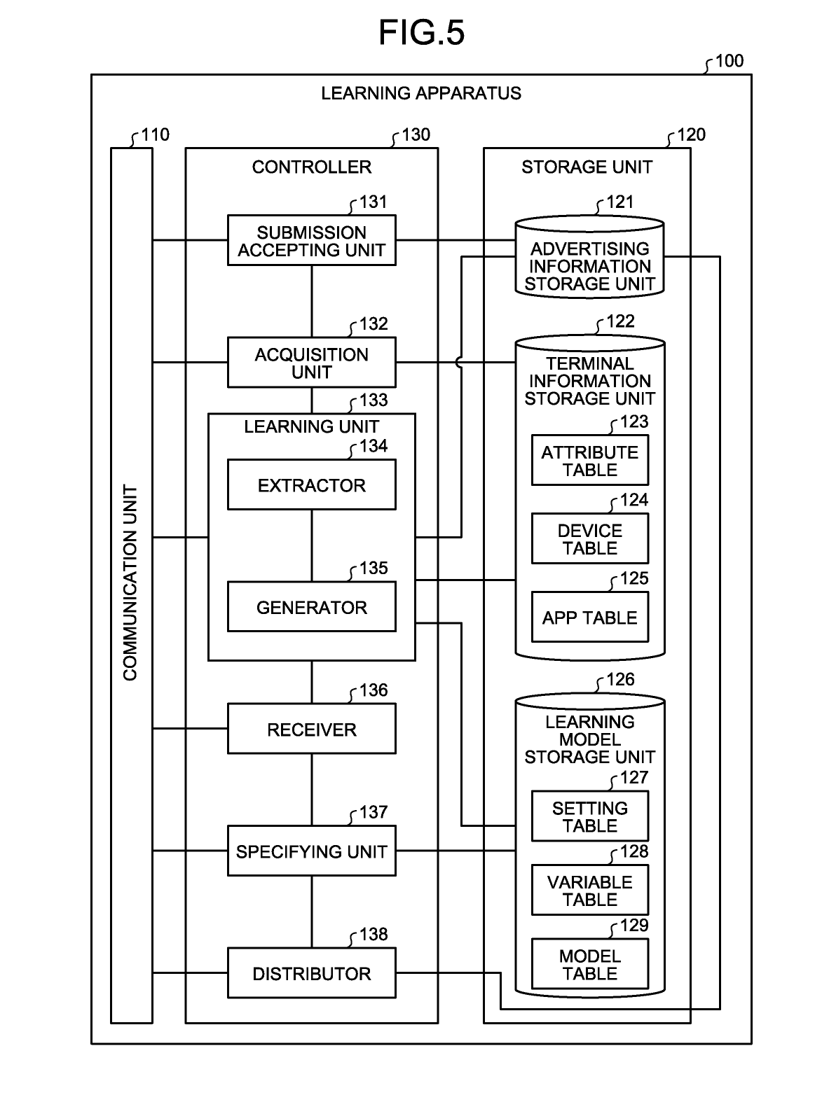

Referring now to FIG. 5, a configuration of the learning apparatus 100 according to the embodiment will be described. FIG. 5 is a diagram illustrating a configuration example of the learning apparatus 100 according to the embodiment. As illustrated in FIG. 5, the learning apparatus 100 includes a communication unit 110, a storage unit 120, and a controller 130. The learning apparatus 100 may include an input unit (for example, a keyboard and a mouse) for accepting a variety of operations from an administrator or the like using the learning apparatus 100, and a display unit (for example, a liquid crystal display) for displaying a variety of information.

Communication Unit 110

The communication unit 110 is implemented by, for example, a network interface card (NIC). Such a communication unit 110 is connected to the network N by wire or by radio to transmit/receive information to/from the user terminal 10, the advertiser terminal 20, and the web server 30 through the network N.

Storage Unit 120

The storage unit 120 is implemented by, for example, a semiconductor memory device such as a random-access memory (RAM) and a flash memory or a storage device such as a hard disk and an optical disc. The storage unit 120 includes an advertising information storage unit 121, a terminal information storage unit 122, and a learning model storage unit 126.

Advertising Information Storage Unit 121

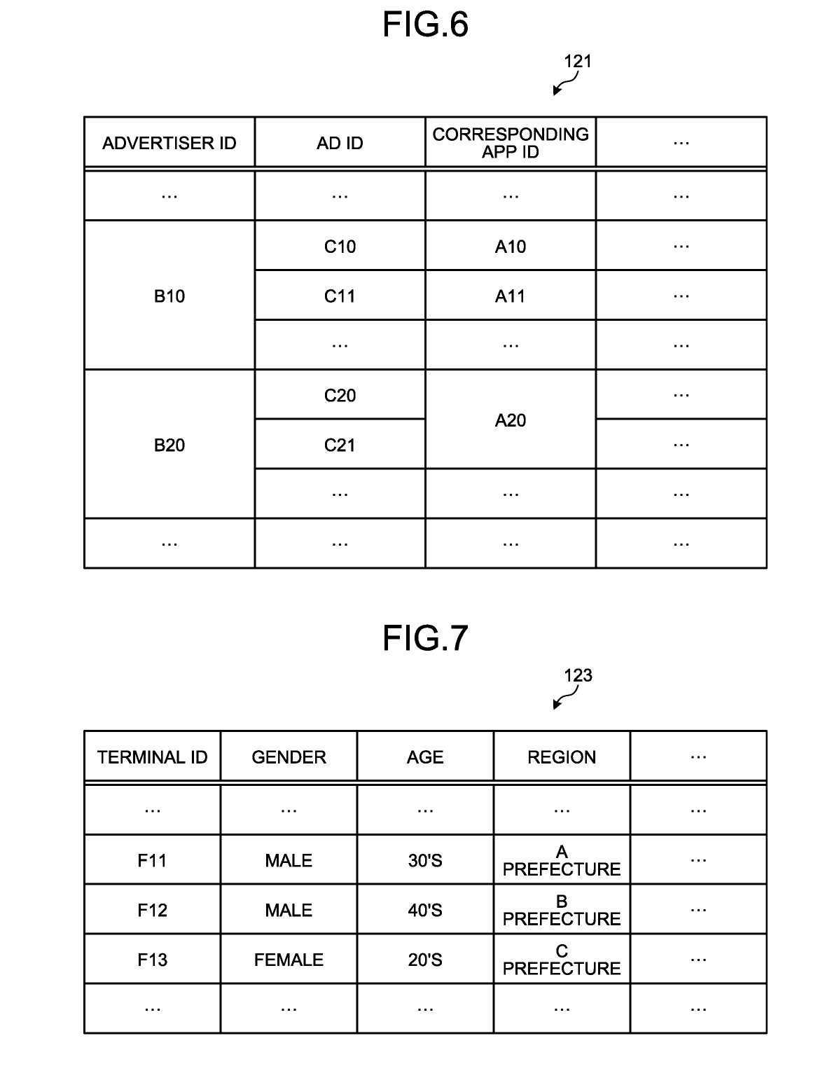

The advertising information storage unit 121 stores information about an advertisement submitted from the advertiser terminal 20. Here, an example of the advertising information storage unit 121 according to the embodiment is illustrated in FIG. 6. FIG. 6 is a diagram illustrating an example of the advertising information storage unit 121 according to the embodiment. In the example illustrated in FIG. 6, the advertising information storage unit 121 has entries such as “advertiser ID”, “ad ID”, and “corresponding app ID”.

The “advertiser ID” indicates identification information for identifying the advertiser or the advertiser terminal 20. The “ad ID” indicates identification information for identifying an advertisement submitted by an advertiser. The “corresponding app ID” indicates identification information for identifying an app associated with an advertisement.

In the present description, the identification information as illustrated in FIG. 6 is used as a reference sign. For example, the advertiser identified by the advertiser ID “B10” may be denoted as “advertiser B10”, the advertisement identified by the ad ID “C10” may be denoted as “ad C10”, and the app identified by the (corresponding) app ID “A10” may be denoted as “app A10”.

That is, the example of data illustrated in FIG. 6 indicates that the advertiser B10 identified by the advertiser ID “B10” submits advertisements identified by the ad IDs “C10” and “C11”. It is also indicated that the app associated with the ad C10 is the app A10 identified by the corresponding app ID “A10”.

An app may not be associated one-to-one with an advertisement but may be associated with a plurality of advertisements. For example, as illustrated in FIG. 6, the app A20 is associated with the ad C20 and the ad C21. This indicates that the ad C20 and the ad C21 are different in content such as advertising image data but they are targeted to the same app A20.

The content data (text data, moving image data, still image data) of an advertisement to be actually distributed to the user terminal 10 may be stored in a predetermined storage server separate from the learning apparatus 100. In this case, the learning apparatus 100 specifies an advertisement stored in the external storage server, based on the ad ID stored in the advertising information storage unit 121. The learning apparatus 100 then controls such that the storage server distributes the specified advertisement to the user terminal 10.

Other information about advertisements may be stored in the advertising information storage unit 121. For example, the conditions of distribution destinations specified for each advertisement and the distribution count (specified impression count) specified for each advertisement may be stored in the advertising information storage unit 121. An index value indicating advertising effectiveness may be stored in the advertising information storage unit 121. For example, index values such as Cost Per Install (CPI) and Click Through Rate (CTR) may be stored for each advertisement in the advertising information storage unit 121.

Terminal Information Storage Unit 122

The terminal information storage unit 122 stores information about the user terminal 10 serving as an advertisement distribution target. As illustrated in FIG. 5, the terminal information storage unit 122 includes, as data tables for storing the terminal information, an attribute table 123, a device table 124, and an app table 125.

Attribute Table 123

Here, an example of the attribute table 123 according to the embodiment is illustrated in FIG. 7. FIG. 7 is a diagram illustrating an example of the attribute table 123 according to the embodiment. The attribute table 123 mainly stores information about attributes of the user who uses the user terminal 10. In the example illustrated in FIG. 7, the attribute table 123 has entries such as “terminal ID”, “gender”, “age”, and “region”.

The “terminal ID” is identification information for identifying the user terminal 10. The “gender” indicates the gender of the user who uses the user terminal 10. The “age” is the age of the user who uses the user terminal 10. The “region” indicates the domicile of the user who uses the user terminal 10. In the “region”, the region name (for example, Kanto region) or the country name indicating a certain range corresponding to the domicile of the user may be stored instead of a specific address.

That is, the example of data illustrated in FIG. 7 indicates that the gender of the user of the user terminal 10 identified by the terminal ID “F11” is “male”, the age is “30's”, and the region of the domicile is “A prefecture”.

The attribute information stored in the attribute table 123 may not necessarily be precise information. For example, the learning apparatus 100 may store “estimated gender”, “estimated age”, and the like, estimated from the device information in the attribute table 123. In addition to the “region”, information such as “urbanization rank” indicating the degree of urbanization of the region may be stored in the attribute table 123.

Device Table 124

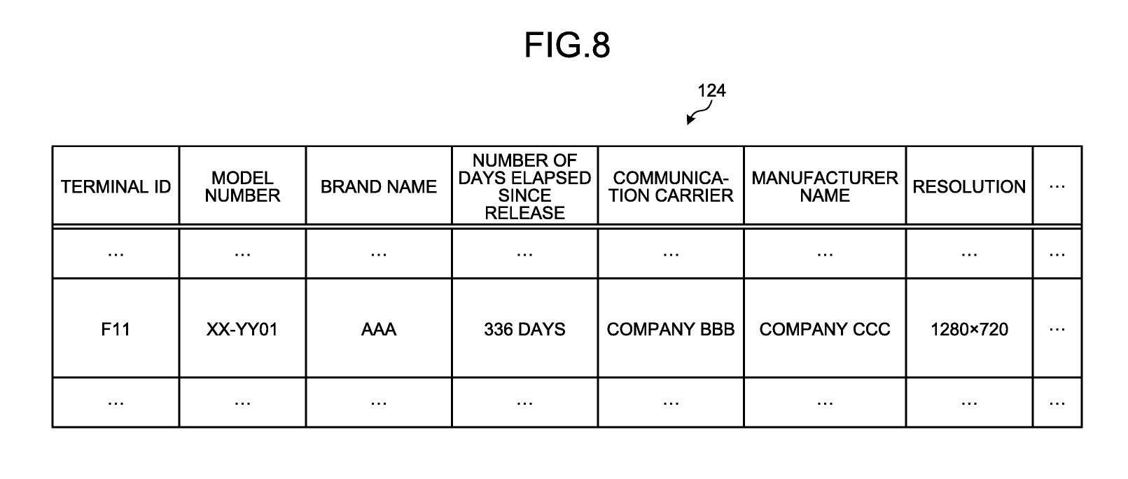

Next, an example of the device table 124 according to the embodiment is illustrated in FIG. 8. FIG. 8 is a diagram illustrating an example of the device table 124 according to the embodiment. The device table 124 mainly stores therein device information indicating the information on the user terminal 10 itself. In the example illustrated in FIG. 8, the device table 124 has entries such as “terminal ID”, “model number”, “brand name”, “number of days elapsed since release”, “communication carrier”, “manufacturer name”, and “resolution”.

The “terminal ID” corresponds to the similar entry as illustrated in FIG. 7. The “model number” indicates the model number of the user terminal 10. The “brand name” indicates the brand name given to the user terminal 10. The “number of days elapsed since release” indicates the number of days elapsed since the user terminal 10 was released. The “communication carrier” indicates the company name of the communication carrier that provides a communication line for the user terminal 10. The “resolution” indicates the resolution of the screen of the user terminal 10.

That is, in the example of data illustrated in FIG. 8, for the user terminal 10 identified by the terminal ID “F11”, it is indicated that the model number is “XX-YY01” and the brand name is “AAA”. For the user terminal 10 identified by the terminal ID “F11”, it is indicated that “336 days” have elapsed since its release, the communication carrier is “Company BBB”, its manufacturer is “Company CCC”, and the resolution is “1280×720”.

App Table 125

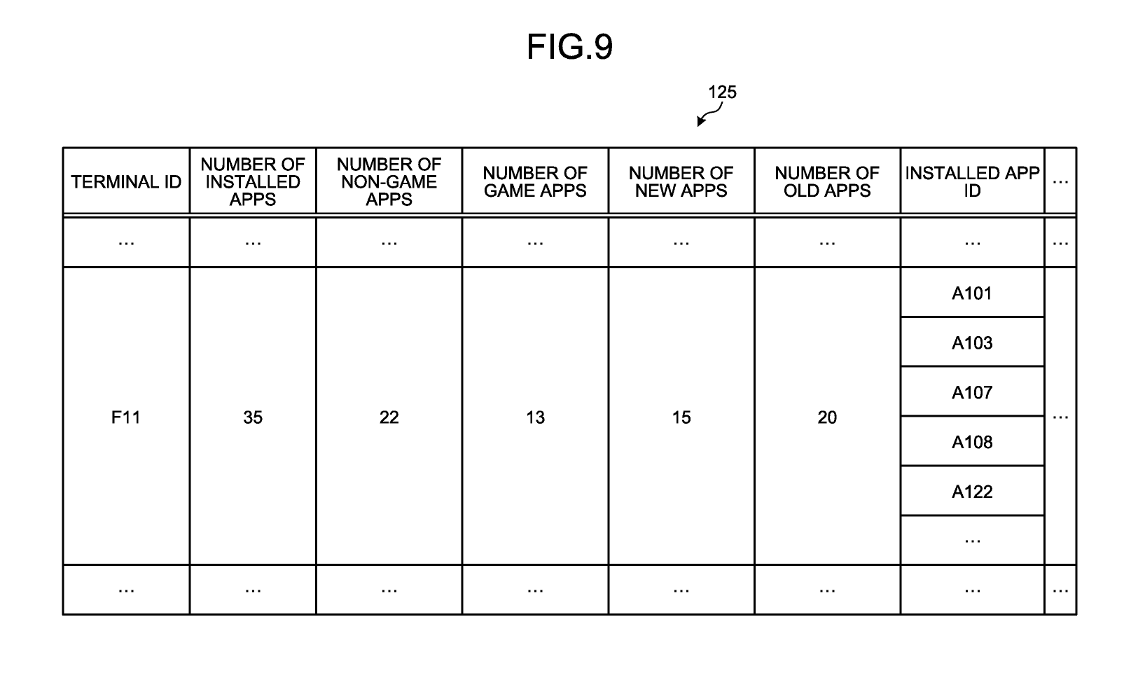

Next, an example of the app table 125 according to the embodiment is illustrated in FIG. 9. FIG. 9 is a diagram illustrating an example of the app table 125 according to the embodiment. The app table 125 mainly stores therein information about apps installed in the user terminal 10. In the example illustrated in FIG. 9, the app table 125 has entries such as “terminal ID”, “number of installed apps”, “number of non-game apps”, “number of game apps”, “number of new apps”, “number of old apps”, and “installed app ID”.

The “terminal ID” corresponds to the similar entry as illustrated in FIG. 7. The “number of installed apps” indicates the total number of apps installed in the user terminal 10. The “number of non-game apps” indicates the number of apps other than game apps, of the installed apps. The “number of game apps” indicates the number of game apps, of the installed apps. The “number of new apps” indicates the number of apps relatively recently (for example, within one year) released, of the installed apps. The “number of old apps” indicates the number of apps excluding the new apps, of the installed apps. The “installed app ID” indicates the identification information of each app installed in the user terminal 10.

That is, in the example illustrated in FIG. 9, it is indicated that “35” apps are installed in the user terminal 10 identified by the terminal ID “F11”. It is also indicated that, of the apps installed in the user terminal 10 identified by the terminal ID “F11”, the number of non-game apps is “22” and the number of game apps is “13”. It is further indicated that, of the apps installed in the user terminal 10 identified by the terminal ID “F11”, the number of new apps is “15” and the number of old apps is “20”. It is also indicated that the apps installed in the user terminal 10 identified by the terminal ID “F11” are apps identified by the identification information such as “A101”, “A103”, “A107”, “A108”, and “A122”.

Learning Model Storage Unit 126

The learning model storage unit 126 stores therein information about the learning process of the learning apparatus 100. As illustrated in FIG. 5, the learning model storage unit 126 includes, as data tables storing information about the learning process, a setting table 127, a variable table 128, and a model table 129.

Setting Table 127

The setting table 127 mainly stores therein information about the settings of terminal information and variables extracted from the terminal information. The setting table 127 further includes a plurality of tables for each kind of the stored information. The settings stored in the setting table 127 may be, for example, input by the administrator of the learning apparatus 100, or automatically set based on information extracted from sites that introduce apps, as will be described later.

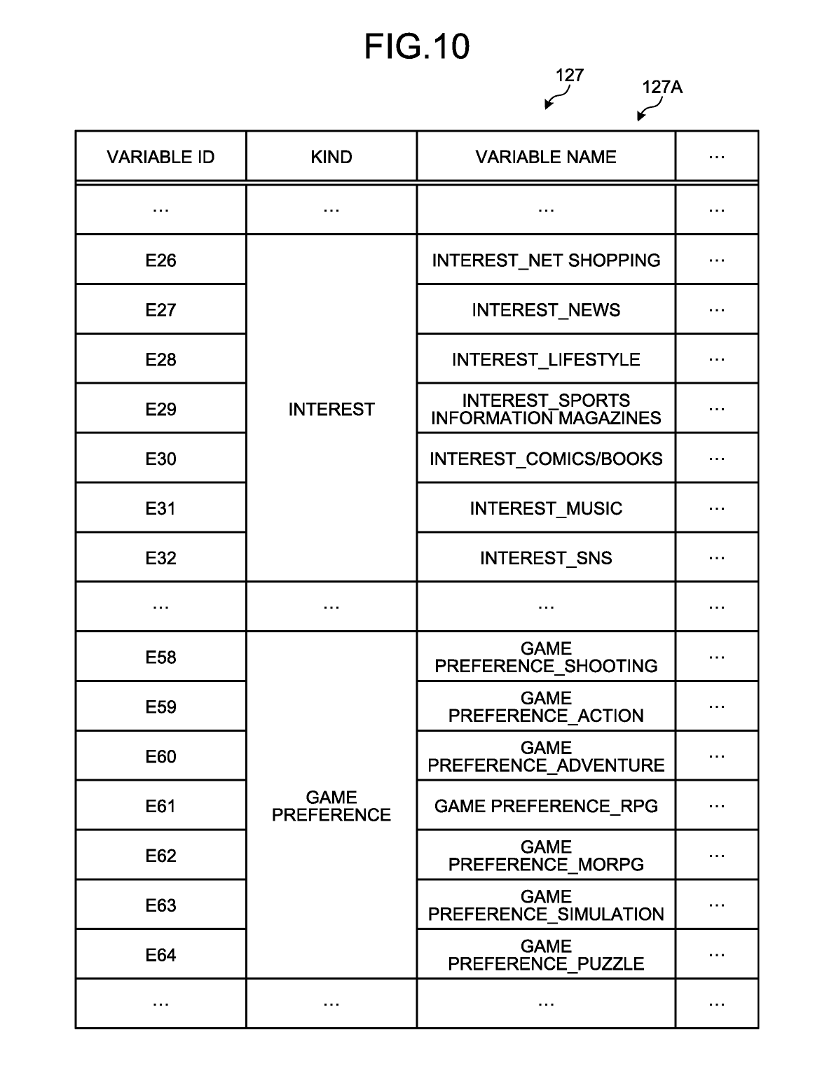

Here, an example of the setting table 127 according to the embodiment is illustrated in FIG. 10. FIG. 10 is a first diagram illustrating an example of the setting table 127 according to the embodiment. FIG. 10 illustrates a variable setting table 127A as an example of the setting table 127, in which the association between the identification information of variables for use in learning and the kinds and contents of variables are set. In the example illustrated in FIG. 10, the variable setting table 127A has entries such as “variable ID”, “kind”, and “variable name”.

The “variable ID” indicates identification information for identifying a variable. The “kind” indicates the kind corresponding to a variable ID. The kind is used for classifying variables. The “variable name” indicates the designation of each of variables classified by subdividing the kind.

That is, in the example of data illustrated in FIG. 10, the variable identified by the variable ID “E26” is a variable related to the kind “interest”, specifically a variable indicating the interest in “net shopping”. The variable identified by the variable ID “E58” indicates a variable related to the kind “game preference”, specifically indicating the interest in “shooting”.

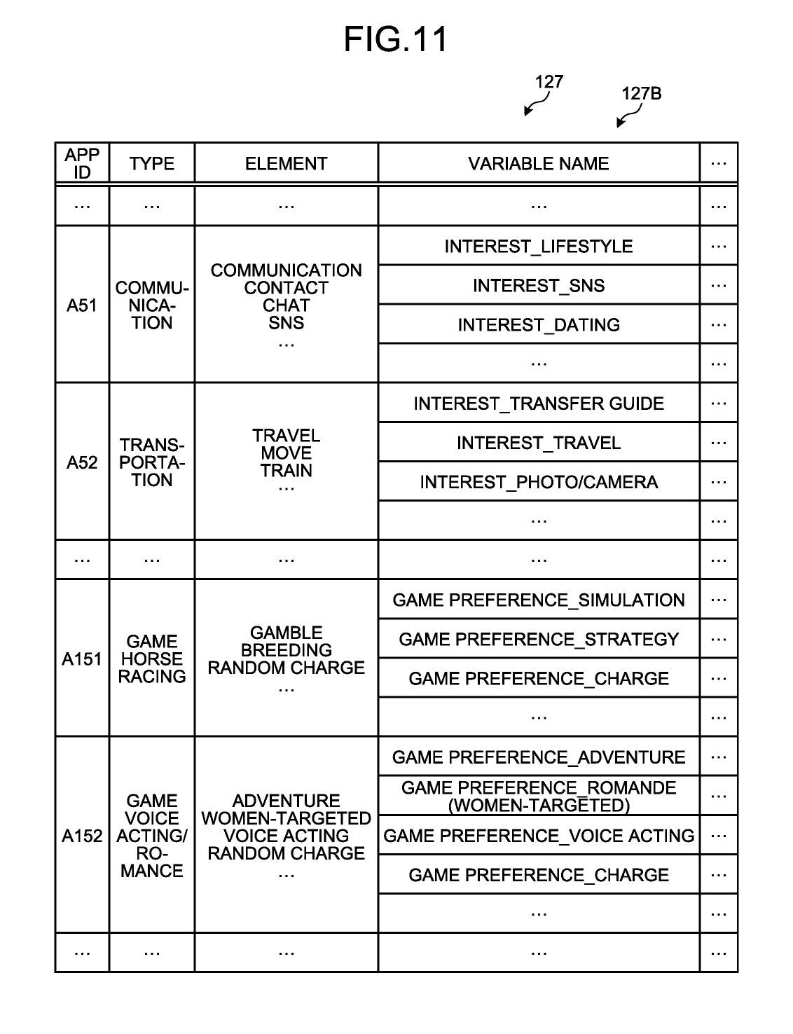

Next, another example of the setting table 127 according to the embodiment is illustrated in FIG. 11. FIG. 11 is a second diagram illustrating an example of the setting table 127 according to the embodiment. FIG. 11 illustrates an app setting table 127B as an example of the setting table 127, in which variables associated with apps are set. In the example illustrated in FIG. 11, the app setting table 127B has entries such as “app ID”, “type”, “element”, and “variable name”.

The “app ID” indicates the identification information for identifying an app. The “type” indicates the type of an app. The “element” indicates elements of an app. The “variable name” indicates a variable set based on the type and the element of an app.

That is, in the example of data illustrated in FIG. 11, the app A51 identified by the app ID “A51” is an app belonging to the type “communication system” and having elements denoted by keywords such as “communication”, “contact”, “chat”, and “SNS”. It is therefore indicated that variables identified by the designations such as “interest_lifestyle”, “interest_SNS”, and “interest dating” are set for the app A51.

Variable Table 128

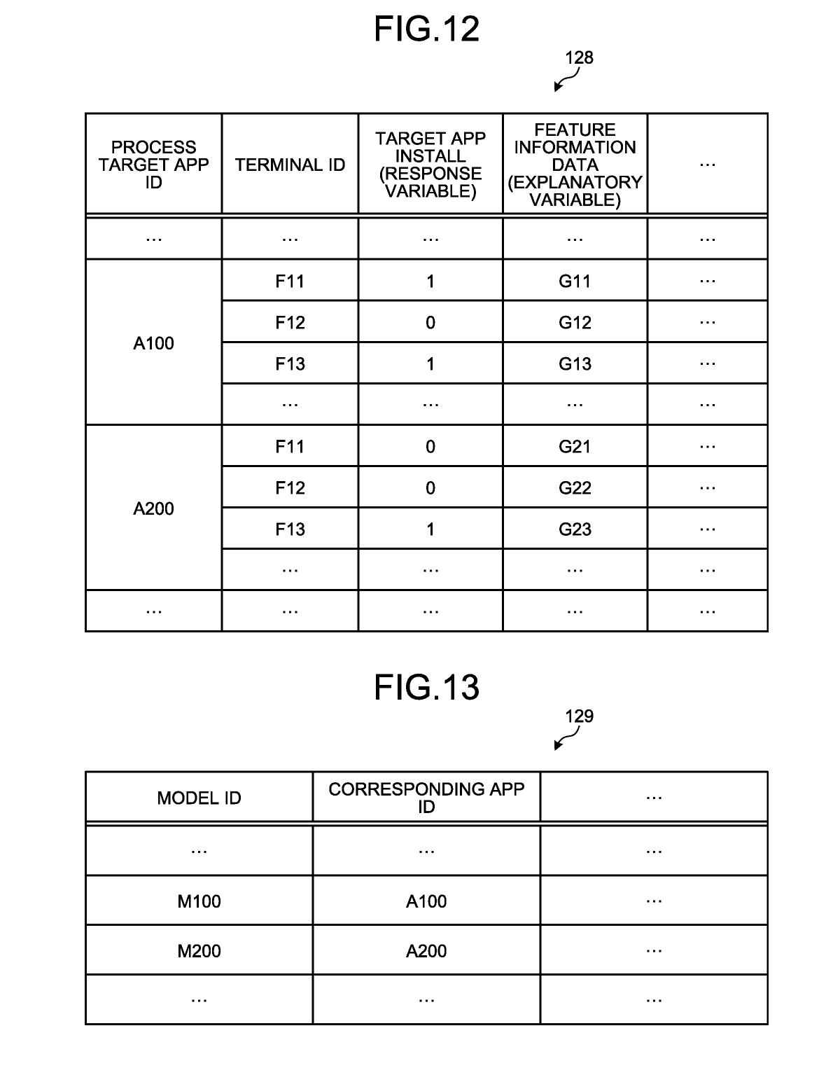

Next, an example of the variable table 128 according to the embodiment is illustrated in FIG. 12. FIG. 12 is a diagram illustrating an example of the variable table 128 according to the embodiment. As illustrated in FIG. 12, the variable table 128 has entries such as “process target app ID”, “terminal ID”, “target app install (response variable)”, and “feature information data (explanatory variable)”.

The “process target app ID” indicates the identification information for identifying an app for which a model is to be generated. The “terminal ID” indicates identification information for identifying a user terminal 10.

The “target app install (response variable)” is information serving as a response variable in the model generated by the learning apparatus 100. Specifically, the “target app install (response variable)” is information indicating whether the app as a process target has been installed in the user terminal 10. In the example in FIG. 12, the entry “target app install (response variable)” set to “1” indicates that the process target app is installed in the user terminal 10. On the other hand, the entry “target app install (response variable)” set to “0” indicates that the process target app is not installed in the user terminal 10.

The “feature information data (explanatory variable)” is information serving as an explanatory variable in the model generated by the learning apparatus 100. Although conceptually denoted as “G11” in the example in FIG. 12, the “feature information data (explanatory variable)” is actually data that encompasses a plurality of explanatory variables held by the user terminal 10. That is, the feature information data is a set of feature information extracted from the terminal information of the user terminal 10 and is data indicating the features of the user terminal 10 (in other words, the user who uses the user terminal 10).

That is, in the example of data illustrated in FIG. 12, it is indicated that the app A100 identified by the process target app ID “A100” is installed in the user terminal 10 identified by the terminal ID “F11” and in the user terminal 10 identified by the terminal ID “F13”. On the other hand, it is indicated that the app A100 is not installed in the user terminal 10 identified by the terminal ID “F12”. It is also indicated that the feature information data of the user terminal 10 identified by the terminal ID “F11” is “G11”, the feature information data of the user terminal 10 identified by the terminal ID “F12” is “G12”, and the feature information data of the user terminal 10 identified by the terminal ID “F13” is “G13”.

Model Table 129

Next, an example of the model table 129 according to the embodiment is illustrated in FIG. 13. FIG. 13 is a diagram illustrating an example of the model table 129 according to the embodiment. As illustrated in FIG. 13, the model table 129 has entries such as “model ID” and “corresponding app ID”.

The “model ID” indicates identification information for identifying a model. The “corresponding app ID” indicates identification information for identifying an app corresponding to a model.

That is, in the example of data illustrated in FIG. 13, the model M100 identified by the model ID “M100” indicates the model corresponding to the app ID “A100”.

Controller 130

The controller 130 is implemented by, for example, a central processing unit (CPU) or a micro processing unit (MPU) executing a variety of programs (equivalent to an example of the learning program) stored in a storage device in the learning apparatus 100 using a RAM as a working area. Alternatively, the controller 130 is implemented by, for example, an integrated circuit such as an application specific integrated circuit (ASIC) and a field programmable gate array (FPGA).

As illustrated in FIG. 5, the controller 130 includes a submission accepting unit 131, an acquisition unit 132, a learning unit 133, an extractor (an extracting unit) 134, a generator (a generating unit) 135, a receiver (a receiving unit) 136, a specifying unit 137, and a distributor (a distributing unit) 138, and implements or executes the functions and operations of information processing detailed below. The internal configuration of the controller 130 is not limited to the configuration illustrated in FIG. 5 and may be any other configuration that performs the information processing described later. The connection relation among the processing units of the controller 130 is not limited to the connection relation illustrated in FIG. 5 and may be any other connection relation.

Submission Accepting Unit 131

The submission accepting unit 131 accepts submission of an advertisement from the advertiser terminal 20. The submission accepting unit 131 then associates the advertiser ID for identifying the submitting advertiser, the ad ID for identifying the advertisement, and the corresponding app ID for identifying the app corresponding to the advertisement with each other for storage into the advertising information storage unit 121.

The submission accepting unit 131 may accept the distribution count specified for each advertisement, the conditions for distribution destination users, and the like from the advertiser. For a case where an advertisement is distributed without using a model corresponding to the advertisement (that is, app), for example, the submission accepting unit 131 may accept a targeting element, such as specification of attributes of the user serving as an advertisement distribution destination.

Acquisition Unit 132

The acquisition unit 132 acquires a variety of information. For example, the acquisition unit 132 acquires terminal information that is information about the user terminal 10 receiving an advertisement. Specifically, the acquisition unit 132 acquires attribute information of the user who uses the user terminal 10 as terminal information. The acquisition unit 132 also acquires device information that is information on the user terminal 10 itself, as terminal information. The acquisition unit 132 also acquires app information that is information about the app installed in the user terminal 10, as terminal information.

The acquisition unit 132 may acquire information about the received advertisement, that is, information about the user's behavior for the advertisement, as terminal information. For example, when the user selects (for example, clicks) an advertisement, the acquisition unit 132 acquires information about the web page that presents the advertisement and the location of the advertisement space. The acquisition unit 132 may acquire time information as to how long has passed since the last time the user selects any given advertisement. The acquisition unit 132 may acquire information such as the advertisement contact time, that is, during which time of a day the user selects advertisements frequently. In this way, the information acquired by the acquisition unit 132 may be used by the learning unit 133 described later as an explanatory variable of the user terminal 10.

The acquisition unit 132 may acquire the result information indicating whether the user terminal 10 receiving an advertisement has taken predetermined behavior related to the advertisement. Specifically, the acquisition unit 132 acquires the result information indicating whether the user terminal 10 has installed an app set as a target of the learning process by the learning unit 133 described later.

The acquisition unit 132 may acquire the terminal information and the result information at any timing. For example, the acquisition unit 132 may acquire the terminal information and the like when a request for advertisement distribution is accepted from the user terminal 10. In a case where a program is set to send predetermined communication from the user terminal 10 to the learning apparatus 100 when an app associated with an advertisement is installed into the user terminal 10, the acquisition unit 132 acquires the terminal information and the like when such communication is accepted. Alternatively, the acquisition unit 132 may acquire the terminal information and the like of the user terminal 10 from an external server at any timing, rather than acquiring the terminal information and the like from the user terminal 10.

The acquisition unit 132 then stores the acquired information into a predetermined storage unit. For example, when acquiring the terminal information, the acquisition unit 132 stores the acquired information into the terminal information storage unit 122. Alternatively, the acquisition unit 132 may send the acquired information to a processing unit such as the learning unit 133.

The acquisition unit 132 may acquire information about advertisements, for example, as to whether the advertisement has been clicked, or whether the app corresponding to the advertisement has been installed, by various know methods. For example, the acquisition unit 132 may acquire information about advertisements using a notification function implemented by a web beacon or the like.

Learning Unit 133

The learning unit 133 learns the relation between the result information indicating whether predetermined behavior related to predetermined information content has been taken and the terminal information. The learning unit 133 then generates a model indicating a tendency to take the predetermined behavior related to the predetermined information content, based on the learning result. Even after generating a model, the learning unit 133 acquires terminal information and continues learning of the model to optimize the model. The learning unit 133 includes the extractor 134 and the generator 135 to implement the process above.

Extractor 134

The extractor 134 extracts feature information characterizing the user terminal 10 from the terminal information acquired by the acquisition unit 132. For example, the extractor 134 extracts information such as the brand name and the number of days elapsed since release of the user terminal 10, based on the device information.

The extractor 134 also extracts feature information charactering the user terminal 10 (that is, the user of the user terminal 10), based on the app information. For example, the extractor 134 specifies an app installed in the user terminal 10. The extractor 134 then specifies the type and elements of the app that are set in the app. The extractor 134 also specifies a variable set based on the type and elements of the app. That is, the extractor 134 specifies a variable to be used in a model described later, as feature information extracted from the terminal information.

The extractor 134 extracts feature information from the terminal information, based on, for example, the settings input by the administrator of the learning apparatus 100. For example, in FIG. 11, the extractor 134 specifies variables such as “interest_lifestyle”, “interest_SNS”, and “interest dating” associated with the app A51. When the app A51 is specified as an app installed in the user terminal 10 to serve as a process target, the extractor 134 extracts the above-noted variables as information characterizing the user terminal 10.

The extractor 134 may extract feature information using information other than the settings input by the administrator of the learning apparatus 100. For example, in the download site of an app, text data that is an introductory sentence for the app may be associated with each app. In this case, the extractor 134 analyzes the text data to extract a keyword serving as the type or element of the app. For example, it is assumed that the extractor 134 performs morphological analysis of the text data associated with the app A51 to extract nouns such as “communication” and “contact”. In this case, the extractor 134 sets the extracted nouns as elements of the app A51, using the extracted nouns as keywords. In addition, the extractor 134 sets variables linked to the words set as elements, as variables corresponding to the app A51. The extractor 134 thus can associate a variable (feature information) with the app without human intervention such as the administrator of the learning apparatus 100.

Generator 135

The generator 135 generates a model indicating a tendency of predetermined behavior related to predetermined information content to be taken, by learning the relation between the result information indicating whether the predetermined behavior related to the predetermined information content has been taken and the terminal information acquired by the acquisition unit 132. Specifically, the generator 135 generates a model indicating a tendency to install a predetermined app, by learning the relation between the result information indicating whether a predetermined app has been installed and the terminal information.

As previously mentioned, the generator 135 generates a model for each app (in other words, “for each advertisement” in a case where there is a one-to-one correspondence between the app and the advertisement). That is, the generator 135 sets the result information indicating whether a predetermined app has been installed, as a response variable in machine learning. The generator 135 then sets the feature information of the user terminal 10 receiving the advertisement associated with the predetermined app, as an explanatory variable in machine learning. The generator 135 then generates a model for the predetermined app, using the response variable and the explanatory variable. The generator 135 thus generates a model capable of accurately specifying the user terminal 10 having a tendency to install the predetermined app.

The generator 135 generates a model using a variety of explanatory variables. For example, the generator 135 uses the feature information of the user extracted from the apps installed in the user terminal 10, as an explanatory variable. As an example, the generator 135 generates a model using interest information that is information specified based on the type or the elements set in the app installed in the user terminal 10 and indicating the interest of the user of the user terminal 10, as feature information extracted from the app information. The generator 135 may generate a model using preference information that is information specified based on the type or the elements set in the game app installed in the user terminal 10 and indicating the game preference of the user of the user terminal 10, as feature information extracted from the app information. As previously mentioned, the extractor 134 may analyze the introductory sentence on the download site or the like whereby the type or the elements of the app may be set for each app. That is, the generator 135 can set the type or the elements of the app installed in the user terminal 10, based on the introduction of the app set for the app by the provider providing the app.

An example of the model generated by the generator 135 will be described below. The learning scheme for the model generated by the generator 135 is not limited to the example below and a variety of known machine learning schemes may be employed.

For example, the generator 135 generates a formula indicating the relation between whether a predetermined app has been installed in the user terminal 10 and the terminal information of the user terminal 10. In addition, the generator 135 calculates what weight each individual feature information extracted from the terminal information of the user terminal 10 has, for an event of a predetermined app being installed. The generator 135 thus can obtain information as to how much each individual feature information contributes to an event of installation of a predetermined app. For example, the generator 135 creates Formula (1) below in generating a model indicating a tendency of the app A100 illustrated in FIG. 12 to be installed.

Y_{(A100)}=ω₁·x₁+ω₂·x₂+ω₃·x₃ . . . +ω_{N}·x_{N} (1)

(where N is any given number.)

Formula (1) above is created, for example, for each user terminal 10 receiving the advertisement associated with the app A100. In Formula (1) above, “y_{(A100)}” indicates an event “whether the app A100 has been installed in the user terminal 10 receiving the advertisement”.

In Formula (1) above, “x” corresponds to each explanatory variable of the user terminal 10. The explanatory variables “x₁, x₂, x₃, . . . , x_{N}” in Formula (1) above correspond to the variables illustrated in FIG. 10. Specifically, when Formula (1) above includes “x₂₆”, “x₂₆” corresponds to the variable ID “E26” illustrated in FIG. 10 and its content is “interest_net shopping”. That is, the right side of Formula (1) above corresponds to the feature information data extracted from the terminal information of the user terminal 10 as illustrated in FIG. 12.

In Formula (1) above, “ω” is a coefficient of “x” and indicates a predetermined weight value. Specifically, “ω₁” is a weight value of “x₁”, “ω₂” is a weight value of “x₂”, and “ω₃” is a weight value of “x₃”. In this way, Formula (1) above is created by combining variables including the explanatory variable “x” corresponding to the feature information extracted from the terminal information and a predetermined weight value “ω” (for example, “ω₁·x₁”).

Referring to FIG. 7 and FIG. 11, a description will be given with specific examples. In the following description, the terminal ID is used as a reference sign for a user, for the sake of convenience. For example, the user of the user terminal 10 identified by the terminal ID “F11” is denoted as “user F11”. In Formula (1) above, suppose that “x₁” is an explanatory variable corresponding to “gender”, “x₂” is an explanatory variable corresponding to “age”, and “x₃” is an explanatory variable corresponding to “region”. In this case, Formula (1) above corresponding to the user F11 can be written as Formula (2) below.

y_{(A100,F11)}(=1)=ω₁·(male)+ω₂·(30's)+ω₃·(A Prefecture)+ω₁·x_{N} (2)

Similarly, for the user F12 and the user F13, Formulae (3) and (4) below can be written as follows.

y_{(A100,F12)}(=0)=ω₁·(male)+ω₂·(40's)+ω₃·(B Prefecture)+ω_{N}·x_{N} (3)

y_{(A100,F13)}(=1)=ω₁·(female)+ω₂·(20's)+ω₃·(C Prefecture)+ω_{N}·x_{N} (4)

The generator 135 generates a formula for each user (for each user terminal 10) such as Formulae (2), (3), and (4) above and uses the generated formula as a sample of machine learning. The generator 135 then performs arithmetic operations of the formula serving as a sample to derive a value corresponding to a predetermined weight value “ω”. That is, the generator 135 determines a predetermined weight value “ω” so as to satisfy Formulae (2), (3), and (4) above. In other words, the generator 135 can determine a weight value “ω” indicating the effect of a predetermined explanatory variable on the response variable “y”. For example, if “gender” contributes more significantly than other variables, as information indicating the feature of the user who installs the app A100, a larger value is calculated for the weight value “ω₁” corresponding to “gender”, compared with other variables. In the example illustrated above, the explanatory variables are attribute information of the user, such as “gender”, “age”, and “region”. In actuality, however, Formula (2) and others above include a variety of explanatory variables, such as the device information of the user terminal 10 and the app information. That is, the generator 135 can generate a model using the terminal information or a variety of feature information extracted from the terminal information as illustrated in FIG. 7 to FIG. 12, as explanatory variables.

As described above, the generator 135 generates a model that associates an event of the tendency of the app A100 to be installed with the terminal information acquired from the user terminal 10. In the calculation process using Formulae (2), (3), and (4) above, considering a predetermined error, the optimum solution for “ω” may be calculated using a technique such as the least-squares method to find an approximation such that the square of the difference from the error is minimized, rather than letting the left side be “1” or “0”.

When feature information extracted from the terminal information of the user terminal 10 is substituted in the generated model, the generator 135 substitutes a numerical value of “1” or “0” for a variable determined by “yes” or “no”, such as “interest_net shopping”. For a variable such as resolution, the generator 135 may apply various known techniques, such as normalizing an event represented as an explanatory variable so as to be treated in a model in accordance with a known technique.

When the acquisition unit 132 acquires new terminal information after a model is generated, the generator 135 may update the model any time. The generator 135 thus can optimize the model indicating the features of the user terminal 10 having a tendency to install an app.

Receiver 136

The receiver 136 receives a request for advertisement distribution. Specifically, the receiver 136 receives a request, transmitted from the user terminal 10 displaying a web page, for distribution of an advertisement to be displayed in an advertisement space included in the web page.

The receiver 136 may accept a request for information provision transmitted from the user terminal 10 and also receive the terminal information from the user terminal 10. For example, the receiver 136 receives identification information for identifying the user terminal 10 as an example of the terminal information of the user terminal 10. In this case, the receiver 136 sends the received information to the acquisition unit 132 and the specifying unit 137.

Specifying Unit 137

The specifying unit 137 specifies a destination user terminal 10 to receive predetermined information content, based on the model generated by the generator 135. Specifically, the specifying unit 137 specifies a user terminal 10 to serve as a distribution destination receiving an advertisement associated with an app, based on the tendency (that is, the output value) indicated by the model indicating the tendency of the app associated with the advertisement to be installed.

For example, when the receiver 136 receives a request for advertisement distribution, the specifying unit 137 acquires the terminal information of the user terminal 10 that has transmitted the request. The specifying unit 137 then inputs the acquired terminal information to the model generated by the generator 135. The specifying unit 137 then determines whether to distribute an advertisement corresponding to the model, based on the result output from the model. For example, the specifying unit 137 calculates the probability that the user installs the app, based on the result output from the model. When the calculated probability indicates a predetermined value or greater, the specifying unit 137 determines to distribute the advertisement corresponding to the model and specifies a user terminal 10 to serve as a distribution destination.

As another example, when the value output from the model exceeds a predetermined threshold, the specifying unit 137 determines that the app corresponding to the model is likely to be installed in a distribution destination user terminal 10. The specifying unit 137 then specifies a distribution destination to receive the advertisement corresponding to the app. On the other hand, when the value output from the model does not exceed a predetermined threshold, the specifying unit 137 determines that the app corresponding to the model is less likely to be installed in a distribution destination user terminal 10. In this case, the specifying unit 137 may repeat inputting of the terminal information to another model, for example, until the value output from the model exceeds a predetermined threshold. Alternatively, the specifying unit 137 may determine to distribute an advertisement without using a model. The specifying unit 137 may determine to distribute an advertisement without using a model also when there is no model corresponding to the advertisement to be distributed. In the case of the example above, the value output by the model is not limited to the probability of installing an app but may be any index value.

Even after a model is generated, the specifying unit 137 may specify a user terminal 10 to receive an advertisement without using the model, in a predetermined case. For example, when the learning process is excessively performed, the specifying unit 137 may always determine to distribute the same advertisement to a certain user terminal 10. In such a case, in order to ensure certain randomness in advertisement distribution, the specifying unit 137 may perform the specifying process without using a model.

Distributor 138

The distributor 138 distributes an advertisement to the user terminal 10 determined as an advertisement distribution destination, based on the result determined by the specifying unit 137.

As previously mentioned, data of the advertisement to be distributed to the user terminal 10 may not actually be stored per se in the advertising information storage unit 121 of the learning apparatus 100. For example, the distributor 138 may transmit a control instruction to a predetermined external storage server to distribute an advertisement to the user terminal 10.

4. Configuration of Terminal Device

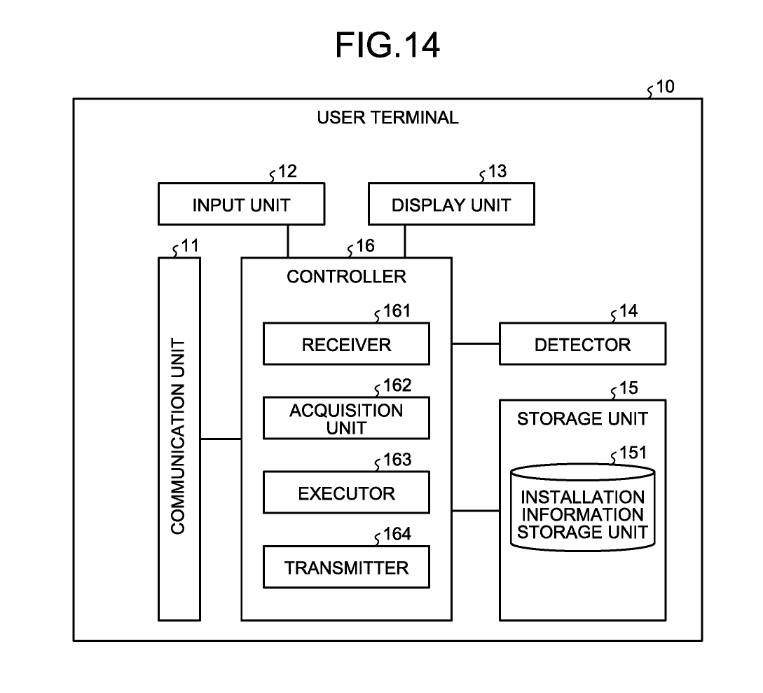

Referring now to FIG. 14, a configuration of the user terminal 10 according to the embodiment will be described. FIG. 14 is a diagram illustrating a configuration example of the user terminal 10 according to the embodiment. As illustrated in FIG. 14, the user terminal 10 includes a communication unit 11, an input unit 12, a display unit 13, a detector 14, a storage unit 15, and a controller 16. The connection relation among the processing units of the user terminal 10 is not limited to the connection relation illustrated in FIG. 14 and may be any other connection relation.

The communication unit 11 is connected to the network N by wire or by radio to transmit/receive information to/from the web server 30 and the learning apparatus 100. For example, the communication unit 11 is implemented by an NIC.

The input unit 12 is an input device that accepts a variety of operations from the user. For example, the input unit 12 is implemented by operation keys provided on the user terminal 10. The input unit 12 may also include an imaging device (for example, camera) for capturing an image and a sound collector (for example, microphone) for collecting sound.

The display unit 13 is a display device for displaying a variety of information. For example, the display unit 13 is implemented by a liquid crystal display. When a touch panel is employed in the user terminal 10, part of the input unit 12 is integrated with the display unit 13.

The detector 14 detects, for example, a variety of operations on the user terminal 10 and information on surroundings of the user terminal 10. For example, the detector 14 is implemented by sensors and antennas for detecting a variety of information. Specifically, the detector 14 detects a communication status of equipment connected to the user terminal 10, the illuminance and noise around the user terminal 10, a physical motion of the user terminal 10, and the positional information of the user terminal 10.

The storage unit 15 stores therein a variety of information. The storage unit 15 is implemented by, for example, a semiconductor memory device such as a RAM and a flash memory or a storage device such as a hard disk and an optical disc. In the example illustrated in FIG. 14, the storage unit 15 includes an installation information storage unit 151. The installation information storage unit 151 stores therein, for example, information on the app installed in the user terminal 10.

The controller 16 is implemented by, for example, a CPU or an MPU executing a variety of programs stored in a storage device in the user terminal 10 using a RAM as a working area. Alternatively, the controller 16 is implemented, for example, by an integrated circuit such as an ASIC or an FPGA.

The controller 16 controls a variety of processing performed in the user terminal 10. As illustrated in FIG. 14, the controller 16 includes a receiver 161, an acquisition unit 162, an executor 163, and a transmitter 164 to implement or execute the functions and operations of information processing described later.

The receiver 161 receives a variety of information. For example, the receiver 161 receives information transmitted from the web server 30 and the learning apparatus 100. Specifically, the receiver 161 receives an advertisement distributed in response to a request for advertisement distribution. The receiver 161 receives a variety of information detected by the detector 14.

The acquisition unit 162 acquires a variety of information and data. For example, the acquisition unit 162 accesses the web server 30 to acquire a web page that the user wishes to view. The acquisition unit 162 acquires, for example, advertisement data received by the receiver 161. The acquisition unit 162 also acquires data for use in installation of an app, for example, through the download site for the app.

The executor 163 executes a variety of processing in the user terminal 10. For example, the executor 163 executes the process of installing an app. When the executor 163 installs an app, information about the installation is stored into the installation information storage unit 151.

The transmitter 164 transmits a variety of information. For example, when the web page acquired by the acquisition unit 162 includes an advertisement space, the transmitter 164 transmits a request for advertisement distribution to the learning apparatus 100. The transmitter 164 refers to, for example, the storage unit 15 to transmit the terminal information of the user terminal 10 to the learning apparatus 100.

5. Process Procedure

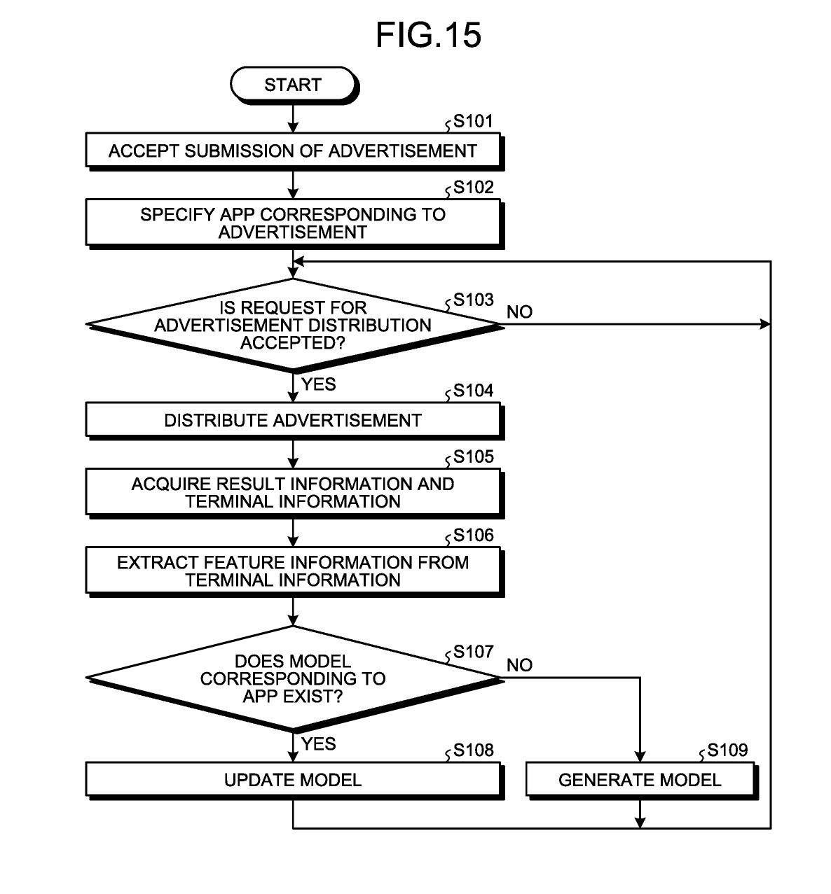

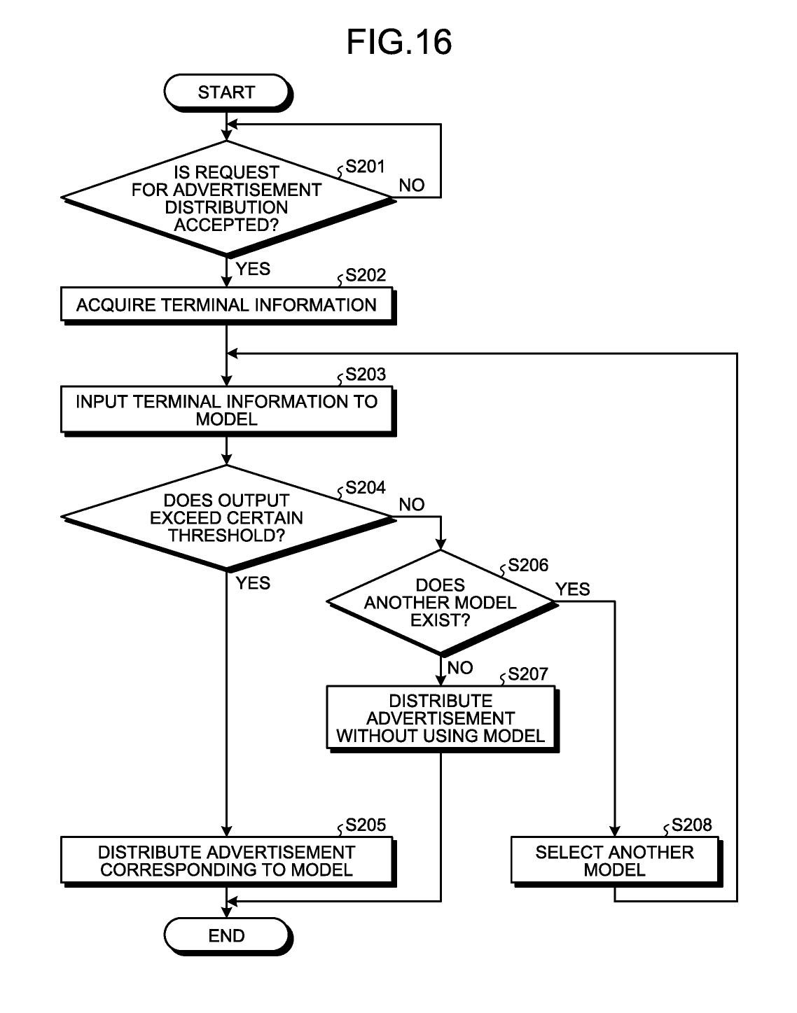

Referring now to FIG. 15 and FIG. 16, the procedure of the process by the learning apparatus 100 according to the embodiment will be described. First of all, referring to FIG. 15, the process procedure for generating a model will be described. FIG. 15 is a first flowchart illustrating the process procedure according to the embodiment.

As illustrated in FIG. 15, the learning apparatus 100 accepts submission of an advertisement from the advertiser terminal 20 (step S101). The learning apparatus 100 then specifies an app corresponding to the submitted advertisement (step S102).

Subsequently, the learning apparatus 100 determines whether a request for advertisement distribution has been accepted from a user terminal 10 (step S103). If a request for advertisement distribution has not been accepted, the learning apparatus 100 waits until accepting (No at step S103).

On the other hand, if a request for advertisement distribution has been accepted (Yes at step S103), the learning apparatus 100 distributes an advertisement to the user terminal 10 that has transmitted the request (step S104). Subsequently, the learning apparatus 100 acquires the result information indicating whether the app corresponding to the advertisement has been installed and the terminal information from the user terminal 10 receiving the advertisement (step S105).

The learning apparatus 100 then extracts feature information from the terminal information (step S106). Subsequently, the learning apparatus 100 determines whether a model corresponding to the app set as a process target has already existed (step S107). If a model exists (Yes at step S107), the learning apparatus 100 performs the model updating process, based on the acquired terminal information (step S108).

On the other hand, if no model exists (No at step S107), the learning apparatus 100 newly performs the model generating process, based on the acquired result information and terminal information (step S109). Subsequently, the learning apparatus 100 optimizes the model by repeating acquisition of the terminal information. When the result information and the terminal information can be acquired from an external server or the like, the learning apparatus 100 may skip the process at steps S101 to S104.

Referring now to FIG. 16, the process procedure for advertisement distribution will be described. FIG. 16 is a second flowchart illustrating the process procedure according to the embodiment.

As illustrated in FIG. 16, the learning apparatus 100 determines whether a request for advertisement distribution has been accepted from a user terminal 10 (step S201). If a request for advertisement distribution has not been accepted, the learning apparatus 100 waits until accepting (No at step S201).

On the other hand, if a request for advertisement distribution has been accepted (Yes at step S201), the learning apparatus 100 acquires the terminal information from the user terminal 10 that has transmitted the request (step S202). The learning apparatus 100 then inputs the acquired terminal information as an explanatory variable to any selected model (step S203).

The learning apparatus 100 then determines whether the output value exceeds a certain threshold (step S204). If a predetermined threshold is exceeded (Yes at step S204), the learning apparatus 100 distributes the advertisement corresponding to the model to the user terminal 10 (step S205).

On the other hand, if the output value does not exceed a certain threshold (No at step S204), the learning apparatus 100 determines whether another model exists (step S206). If another model does not exist (No at step S206), the learning apparatus 100 distributes an advertisement without using a model (step S207).

On the other hand, if another model exists (Yes at step S206), the learning apparatus 100 selects another model (step S208). The learning apparatus 100 then repeats the process of inputting the terminal information to the selected model (step S203).

6. Modifications

The learning apparatus 100 described above may be carried out in a variety of different modes other than the foregoing embodiment. Another embodiment of the learning apparatus 100 will be described below.

6-1. Kinds of Variables

In the example illustrated in the foregoing embodiment, the acquisition unit 132 acquires the attribute information of the user of the user terminal 10, the device information of the user terminal 10, and the app information as terminal information. In the example illustrated above, the extractor 134 extracts feature information based on the information acquired by the acquisition unit 132. The acquisition unit 132 and the extractor 134 are not limited to these examples and may further acquire a variety of terminal information or extract feature information.

For example, the acquisition unit 132 may acquire the kind and version information of the operating system (OS) of the user terminal 10, the resolution of portrait screen or landscape screen, and the total number of pixels. The acquisition unit 132 may acquire, for example, the proportion of game apps in the apps installed in the user terminal 10.

The extractor 134 may extract a variable other than those illustrated in FIG. 10 as the feature information extracted from the terminal information. For example, if the kind of feature information extracted is interest, the extractor 134 may extract, as feature information (explanatory variable), a variety of information such as part-time jobs and job switches, dating and marriage, houses and cars, family budgets, coupons and shopping points, killing time, sports such as golf, English and other languages, cooking, travel, fashion, and brands, diet, women-targeted products and student-targeted products, flea market, and illustration and photos. The extractor 134 extracts a variable corresponding to interest, for example, based on the elements set for each app.

When the kind of the feature information extracted from the terminal information is game preference, the extractor 134 may extract, as feature information (explanatory variable), a variety of information, such as categories other than the categories illustrated in FIG. 10 (for example, sports, casual, boards, romance, pretty girls, breeding, Warring/Records of the Three Kingdoms), card, strategy, scenario, gambling, characters, and free/pay. That is, the extractor 134 can extract information that the user of the user terminal 10 has installed such a game app that is given variables such as “game preference_card” and “game preference_strategy”. The specifying unit 137 then inputs the extracted information as explanatory variables to the model whereby information can be output as to whether there is a tendency of the app associated with the model to be installed by the user.

6-2. Kinds of Information Content

In the foregoing embodiments, an advertisement associated with an app has been illustrated as an example of the information content provided for users. However, the information content is not limited to such advertisements. For example, the information content may be an advertisement that is not associated with an app and, when selected, displays a landing page. In this case, the generator 135 may generate a model in which “clicking on an advertisement” is a response variable. The specifying unit 137 thus can specify a user having a tendency to click on the distributed advertisement to distribute the advertisement.

The information content is not limited to advertisements and may be recommendation information of products. In this case, the generator 135 may generate a model in which “recommended product being purchased” is a response variable. The specifying unit 137 thus can specify a user having a tendency to purchase the recommended product to provide recommendation information.

6-3. Relation with Media

In the example illustrated in the foregoing embodiments, the specifying unit 137 specifies a user terminal 10 to receive an advertisement, based on the model generated by the generator 135. Here, the specifying unit 137 may further perform the specifying process, based on a predetermine condition accepted from the advertiser.

For example, some advertisers may designate a media content (for example, web page and app) that presents an advertisement submitted by the advertisers. Specifically, in order to enhance the appeal effect by advertisements, the advertiser may wish to display its advertisement on the content containing information in a particular category. Alternatively, the advertiser may wish not to display an advertisement submitted by the advertiser itself on a web page provided by a competitor.

In this case, the specifying unit 137 may specify a user terminal 10 to receive an advertisement, considering a condition specified by the advertiser in addition to the result output by the model. The advertiser thus can prevent an advertisement from appearing on a web page on which the advertiser does not wish to post its own advertisement, even when the web page is displayed by the user who is likely to install.

6-4. Use of External Information

When even more detailed information about the user who uses the user terminal 10 can be used as terminal information to generate a model, the learning apparatus 100 may use such information. For example, the learning apparatus 100 acquires the result of a public survey published by a public institution in connection with users. As an example, the learning apparatus 100 acquires the result of a survey as to the relation between the average annual income of domestic people including users and the region. If the region of the user can be specified, the learning apparatus 100 may use the average annual income in that region as one of the feature information.

As another example, the learning apparatus 100 acquires the result of a survey, for example, as to the relation between the average time spent for entertainment and parenting by domestic people including the user and the age. When the age of the user can be specified or estimated, the learning apparatus 100 may use the average time spent for entertainment and parenting corresponding to the specified or estimated age as one of feature information. Through such a process, the learning apparatus 100 can generate a model using information difficult to obtain from terminals. The learning apparatus 100 thus can obtain feature information that provides more precise features of users.

7. Hardware Configuration

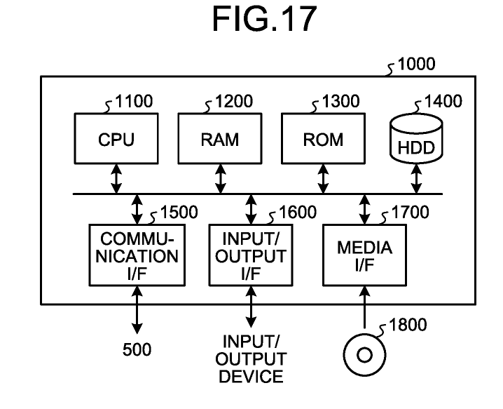

The learning apparatus 100 and the user terminal 10 according to the embodiments described above are each implemented, for example, by a computer 1000 having a configuration as illustrated in FIG. 17. The learning apparatus 100 is taken as an example in the description below. FIG. 17 is a hardware configuration diagram illustrating an example of the computer 1000 that implements the functions of the learning apparatus 100. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 operates based on a program stored in the ROM 1300 or the HDD 1400 to control each unit. The ROM 1300 stores therein, for example, a boot program executed by the CPU 1100 at start-up of the computer 1000 and a program dependent on the hardware of the computer 1000.

The HDD 1400 stores, for example, a program executed by the CPU 1100 and data used by the program. The communication interface 1500 receives data from another device through a communication network 500 (corresponding to the network N illustrated in FIG. 4), sends the received data to the CPU 1100, and transmits data generated by the CPU 1100 to another device through the communication network 500.

The CPU 1100 controls an output device such as a display and a printer and an input device such as a keyboard and a mouse through the input/output interface 1600. The CPU 1100 acquires data from the input device through the input/output interface 1600. The CPU 1100 outputs the generated data to the output device through the input/output interface 1600.

The media interface 1700 reads a program or data stored in a recording medium 1800 and provides the CPU 1100 with the read program or data through the RAM 1200. The CPU 1100 loads such a program from the recording medium 1800 onto the RAM 1200 through the media interface 1700 and executes the loaded program. Examples of the recording medium 1800 include optical recording media such as digital versatile discs (DVD) and phase change rewritable discs (PD), magneto-optical recording media such as magneto-optical discs (MO), tape media, magnetic recording media, and semiconductor memories.

For example, when the computer 1000 functions as the learning apparatus 100 according to an embodiment, the CPU 1100 of the computer 1000 executes the program loaded on the RAM 1200 to implement the functions of the controller 130. Data in the storage unit 120 is stored in the HDD 1400. The CPU 1100 of the computer 1000 reads these programs from the recording medium 1800. Alternatively, these programs may be acquired from another device through the communication network 500.

8. Others

Of the processes described in the foregoing embodiments, all or some of the processes automatically performed in the description above may be performed manually, or all or some of the processes manually performed in the description above may be performed automatically by known methods. Moreover, the process procedure, specific designations, and information including data and parameters illustrated in the written description and the figures can be changed as desired unless otherwise specified. For example, a variety of information illustrated in the figures is not limited to the illustrated information.

The components of each device illustrated in the figures are functional and conceptual and may not necessarily be physically configured as illustrated in the figures. That is, a specific manner of distribution and integration of the devices is not limited to the one illustrated in the figures, and all or some of the devices may be functionally or physically distributed and/or integrated in any units, depending on loads and use conditions. For example, the acquisition unit 132 and the receiver 136 illustrated in FIG. 5 may be integrated. The specifying unit 137 illustrated in FIG. 5 may be distributed into a calculation unit for calculating the probability that the user terminal 10 installs an app based on a model, a determination unit for determining whether to distribute an advertisement to the user terminal 10 based on the calculation result, and a specifying unit for specifying a distribution destination user terminal 10 based on the determination result. For example, the information stored in the storage unit 120 may be stored in a predetermined external storage device through the network N.

In the example illustrated in the foregoing embodiments, the learning apparatus 100 performs, for example, the accepting process of accepting submission of an advertisement (information content), the learning process of learning the relation between the app and the user, and the distribution process of distributing an advertisement. However, the learning apparatus 100 described above may be divided into an accepting device performing the accepting process, a learning apparatus performing the learning process, and a distribution device performing the distribution process. In this case, the accepting device at least includes the submission accepting unit 131. The learning apparatus at least includes the learning unit 133. The distribution device at least includes the distributor 138. The processing by the learning apparatus 100 described above is implemented by the learning process system 1 including the accepting device, the learning apparatus, and the distribution device.

The foregoing embodiments and modification can be combined as appropriate without causing a contradiction in the processing.

9. Advantageous Effects

As described above, the learning apparatus 100 according to the embodiments includes the acquisition unit 132, the generator 135, and the specifying unit 137. The acquisition unit 132 acquires terminal information that is information about the user terminal 10 receiving information content (for example, advertisement). The generator 135 generates a model indicating a tendency of predetermined behavior related to predetermined information content to be taken, by learning the relation between the result information indicating whether the predetermined behavior related to the predetermined information content has been taken and the terminal information acquired by the acquisition unit 132. The specifying unit 137 specifies a destination user terminal 10 to receive predetermined information content, based on the model generated by the generator 135.

In this way, the learning apparatus 100 according to the embodiments can generate a model corresponding to information content by learning the relation between predetermined behavior for the provided information content and the terminal information of the destination receiving the information content. The learning apparatus 100 can specify a destination of information content using the tendency provided by the generated model (for example, the probability that predetermined behavior related to predetermined information content is taken), thereby appropriately matching the information content to be provided with a destination user.

The generator 135 generates a model by learning the relation between the result information and the feature information, which is information extracted from the terminal information and indicating the feature of the user terminal 10 or the user who uses the user terminal 10.

In this way, the learning apparatus 100 according to the embodiments extracts information indicating the feature of the user terminal 10 or the user of the user terminal 10 from the acquired terminal information. The learning apparatus 100 thus can acquire a lot of information indicating the features of the user terminal 10 or the user of the user terminal 10 and allows the features of the destination of information content to be reflected in the model more precisely. The learning apparatus 100 thus can improve the accuracy of the generated model.

The generator 135 generates a model using the attribute information, which is information indicating an attribute of the user, as feature information extracted from the terminal information. Specifically, the generator 135 generates a model using at least one of the gender, age, and domicile of the user as attribute information.

In this way, the learning apparatus 100 according to the embodiments generates a model using the attribute information of the user. The attribute information of the user includes a lot of information indicating the identity of the user, such as age and gender. That is, the learning apparatus 100 can generate a model that more reflects the features of the user, by generating a model using the attribute information. The learning apparatus 100 thus can improve the accuracy of the model.

The acquisition unit 132 acquires device information that is information on the user terminal 10 as a product, as terminal information. The generator 135 generates a model using the feature information extracted from the device information. Specifically, the generator 135 generates a model using at least one of the model number, the brand name, the time elapsed since release, the communication carrier name, the manufacturer name, and the resolution set in the user terminal 10, as feature information extracted from the device information.

In this way, the learning apparatus 100 according to the embodiments acquires information on the user terminal 10 as a product and uses the acquired information as information indicating the feature of the destination of the information content. The information as a product includes brand and specs and therefore serves as an element that reflects the feature such as preference and personality of the user who uses the user terminal 10. The learning apparatus 100 then allows the device information to be reflected in the model thereby inputting the features of the user in various aspects. Therefore, the generated model can precisely specify a user to serve as a destination receiving information content.

The acquisition unit 132 acquires terminal information about the user terminal 10 that can receive an advertisement related to an app and into which the add can be installed. The generator 135 generates a model indicating the tendency of a predetermined app to be installed, by learning the relation between the result information indicating whether the predetermined app has been installed in the user terminal 10 and the terminal information acquired by the acquisition unit 132. The specifying unit 137 specifies a user terminal 10 to serve as a destination receiving the advertisement related to a predetermined app, based on the model generated by the generator 135.

The learning apparatus 100 according to the embodiments thus can generate a model that determines a user likely to install the app associated with the advertisement. The learning apparatus 100 then specifies an advertisement distribution destination based on the model and distributes an advertisement to a user having a similar tendency as the user who installed the app in the past. The learning apparatus 100 thus can appropriately match the advertisement to be distributed with a distribution destination user.

The acquisition unit 132 acquires app information that is information about the app installed in the user terminal 10, as terminal information. The generator 135 generates a model indicating a tendency to install a predetermined app, by learning the relation between the result information and the feature information extracted from the app information.

In this way, the learning apparatus 100 according to the embodiments can accurately estimate, for example, a user having a tendency to install similar apps, by acquiring the information about the app already installed in the user terminal 10. The learning apparatus 100 thus can improve the accuracy of the generated model.

The generator 135 generates a model using, as the feature information extracted from the app information, at least one of the total number of apps installed in the user terminal 10, the number of game apps installed in the user terminal 10, the number of apps, excluding games, installed in the user terminal 10, and the ratio between the total number of apps and the number of game apps installed in the user terminal 10.

In this way, the learning apparatus 100 according to the embodiments uses information about the number of apps installed in the user terminal 10 as feature information. Such information may serve as information indicating the behavior and features of users, for example, indicating that users having a larger number of apps installed in the user terminal 10 are more likely to install a new app, or users having a larger number of game apps are more likely to install another game app. The learning apparatus 100 learns such information to generate a model thereby improving the accuracy of the model.

The generator 135 generates a model using, as feature information extracted from the app information, interest information that is information specified based on the type or elements set for the app installed in the user terminal 10 and indicating the interest of the user of the user terminal 10. The generator 135 may generate a model using, as feature information extracted from the app information, preference information that is information specified based on the type or elements set for the game app installed in the user terminal 10 and indicating the game preference of the user of the user terminal 10.

In this way, the learning apparatus 100 according to the embodiments extracts feature information characterizing the user, considering not only the number of installed apps but also the type of the app and the elements of the app. The learning apparatus 100 can therefore characterize the user in details and allow the information to be reflected in the model thereby improving the accuracy of the model.

The generator 135 sets the type or elements of the app installed in the user terminal 10, based on the introduction of the app set for the app by the provider providing the app.

In this way, the learning apparatus 100 according to the embodiments can set the type or elements for the app, for example, by analyzing the introductory sentence of the app that is registered in the download site for the app. The learning apparatus 100 thus can automatically set the type or elements of the app, without human intervention in characterizing the app with type and elements. The learning apparatus 100 can therefore alleviate the time and effort of the administrator of the learning apparatus 100, for example.

Although the embodiments of the subject application have been described in details above with reference to the figures, they are illustrated only by way of example. The present invention can be carried out not only in the modes described in the disclosure of the invention but also in other modes modified or improved based on the knowledge of those skilled in the art.

The “section, module, or unit” can read as “means”, “circuit”, or the like. For example, the acquisition unit can read as acquisition means or acquisition circuit.

According to a mode of embodiments, the information content to be provided can be appropriately matched with a destination user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A learning apparatus comprising:
an acquisition unit that acquires terminal information that is information about a terminal device receiving information content;
a generating unit that generates a model indicating a tendency of predetermined behavior related to predetermined information content to be taken, by learning a relation between result information and the terminal information acquired by the acquisition unit, the result information indicating whether the predetermined behavior related to the predetermined information content has been taken; and
a specifying unit that specifies a terminal device to serve as a destination receiving the predetermined information content, based on the model generated by the generating unit.

2. The learning apparatus according to claim 1, wherein
the generating unit generates the model by learning a relation between the result information and feature information extracted from the terminal information, the feature information being information indicating a feature of the terminal device or a user using the terminal device.

3. The learning apparatus according to claim 2, wherein
the generating unit generates the model, using attribute information as the feature information extracted from the terminal information, the attribute information being information indicating an attribute of the user.

4. The learning apparatus according to claim 3, wherein
the generating unit generates the model, using at least one of gender, age, and domicile of the user, as the attribute information.

5. The learning apparatus according to claim 2, wherein
the acquisition unit acquires device information as the terminal information, the device information being information on the terminal device as a product, and
the generating unit generates the model, using feature information extracted from the device information.

6. The learning apparatus according to claim 5, wherein
the generating unit generates the model, using at least one of model number, brand name, time elapsed since release, communication carrier name, manufacturer name, and resolution set for the terminal device, as the feature information extracted from the device information.

7. The learning apparatus according to claim 1, wherein
the acquisition unit acquires terminal information about a terminal device capable of receiving an advertisement related to an app and capable of installing the app,
the generating unit generates a model indicating a tendency of a predetermined app to be installed, by learning a relation between result information and the terminal information acquired by the acquisition unit, the result information indicating whether the predetermined app has been installed in the terminal device, and
the specifying unit specifies a terminal device to serve as a destination receiving an advertisement related to the predetermined app, based on the model generated by the generating unit.

8. The learning apparatus according to claim 7, wherein
the acquisition unit acquires app information as the terminal information, the app information being information about an app installed in the terminal device, and
the generating unit generates a model indicating a tendency of the predetermined app to be installed, by learning a relation between the result information and feature information extracted from the app information.

9. The learning apparatus according to claim 8, wherein
the generating unit generates the model, using at least one of the total number of apps installed in the terminal device, the number of game apps installed in the terminal device, the number of apps, excluding games, installed in the terminal device, and the ratio between the total number of apps and the number of game apps installed in the terminal device, as the feature information extracted from the app information.

10. The learning apparatus according to claim 8, wherein
the generating unit generates the model, using interest information as the feature information extracted from the app information, the interest information being information specified based on a type or an element set for an app installed in the terminal device and indicating interest of a user of the terminal device.

11. The learning apparatus according to claim 8, wherein
the generating unit generates the model, using preference information as the feature information extracted from the app information, the preference information being information specified based on a type or an element set for a game app installed in the terminal device and indicating a game preference of a user of the terminal device.

12. The learning apparatus according to claim 10, wherein
the generating unit sets a type or an element of an app installed in the terminal device, based on introduction of the app set for the app by a provider providing the app.

13. A learning method executed by a computer, the learning method comprising:
acquiring terminal information that is information about a terminal device receiving information content;
generating a model indicating a tendency of predetermined behavior related to predetermined information content to be taken, by learning a relation between result information and the terminal information acquired at the acquiring, the result information indicating whether the predetermined behavior related to the predetermined information content has been taken; and
specifying a terminal device to serve as a destination receiving the predetermined information content, based on the model generated at the generating.

14. A non-transitory computer readable storage medium having stored therein a learning program causing a computer to execute a process comprising:
acquiring terminal information that is information about a terminal device receiving information content;
generating a model indicating a tendency of predetermined behavior related to predetermined information content to be taken, by learning a relation between result information and the terminal information acquired at the acquiring, the result information indicating whether the predetermined behavior related to the predetermined information content has been taken; and
specifying a terminal device to serve as a destination receiving the predetermined information content, based on the model generated at the generating.
